(19) United States
(12) Patent Application Publication
(10) Pub. No.: US 2025/0063336 A1
(43) Pub. Date: Feb. 20, 2025

(54) METHOD OF USER EQUIPMENT (UE), METHOD OF COMMUNICATION APPARATUS, UE AND COMMUNICATION APPARATUS

(71) Applicant: NEC CORPORATION, Tokyo (JP)

(72) Inventors: Kundan TIWARI, Tokyo (JP); Toshiyuki TAMURA, Tokyo (JP); iskren Ianev, Tokyo (JP)

(73) Assignee: NEC CORPORATION, Minato-ku, Tokyo (JP)

(21) Appl. No.: 18/728,522

(22) PCT Filed: Jan. 17, 2023
(86) PCT No.: PCT/JP2023/001076

§ 371 Date: Jul. 12, 2024

(30) Foreign Application Priority Data
Jan. 27, 2022 (IN) 202211004541

(51) Int. Cl. H04W 8/18

(52) U.S. Cl. CPC H04W 8/18

(57) ABSTRACT

The Policy Control Function (PCF) provides UE policy (e.g. URSP, ANDSP, V2XP) to a UE supporting the S1 and N1 mode when the UE is registered in the 5GS. In addition, the UE policy is also used while the UE is registered to the EPS. In current 3GPP specifications, there is no procedure defined for sending the UE policy to the UE when the UE is attached to the EPS. In absence of the UE policy, user data from the UE cannot be routed properly when the UE is registered to EPS. A method of a User Equipment (UE) includes sending, to a Mobility Management Entity (MME), a first message including information to obtain a UE policy, and receiving, from the MME, a second message including the UE policy.

### TECHNICAL FIELD

This present disclosure relates to a method of a User Equipment (UE), a method of a communication apparatus, a UE and a communication apparatus.

### BACKGROUND ART

In SA Plenary #94e meeting, NPL 2 Study on Enhancement of 5G UE Policy has been agreed as new study item in 3GPP Release 18. This Study includes the following objective.

#5 although the handling of UE policies (i.e., URSP) interworking in 5GS and EPS has been specified in TS 24.526, there are networks without ANDSF deployments or the UE will not be able to receive URSP in EPC. In such cases, there is discrepancy in UE behavior when it is under EPC coverage as it is lacking policies for the EPC side and the UE policies cannot be updated.

### CITATION LIST

### Non Patent Literature

[NPL 1] 3GPP TR 21.905: “Vocabulary for 3GPP Specifications”. V17.1.0 (2021-12)
[NPL 2] SP-211641 “Study on Enhancement of Network Slicing Phase 3” https://www.3gpp.org/ftp/tsg_sa/TSG_SA/TSGS_94E_Electronic_2 021_12/Docs/SP-211641.zip
[NPL 3] 3GPP TS 24.526: “User Equipment (UE) policies for 5G System (5GS) Stage 3”. V17.5.0 (2021-12)
[NPL 4] 3GPP TS 23.501: “System architecture for the 5G System (5GS)”. V17.3.0 (2021-12)
[NPL 5] 3GPP TS 23.502: “Procedures for the 5G System (5GS)”. V17.3.0 (2021-12)
[NPL 6] 3GPP TS 23.503: “Policy and charging control framework for the 5G System (5GS) Stage 2”. V17.3.0 (2021-12)
[NPL 7] IETF RFC 5580: “Carrying Location Objects in RADIUS and Diameter”. (2009-08)
[NPL 8] 3GPP TS 23.401: General Packet Radio Service (GPRS) enhancements for Evolved Universal Terrestrial Radio Access Network. V17.3.0 (2021-12).
[NPL 9] 3GPP TS 24.301: Non-Access-Stratum (NAS) protocol for Evolved Packet System (EPS) Stage 3. V17.5.0 (2022-01).
[NPL 10] 3GPP TS 24.526: User Equipment (UE) policies for 5G System (5GS) Stage 3. V17.5.0 (2022-01)
[NPL 11] 3GPP TS 24.501: Non-Access-Stratum (NAS) protocol for 5G System (5GS) Stage 3. V17.5.0 (2022-01).

### SUMMARY OF INVENTION

### Technical Problem

The Policy Control Function (PCF) provides UE policy (e.g. URSP, ANDSP, V2XP) to a UE supporting the S1 and N1 mode when the UE is registered in the 5GS. In addition, the UE policy is also used while the UE is registered to the EPS.

In current 3GPP specifications, there is no procedure defined for sending the UE policy to the UE when the UE is attached to the EPS. In absence of the UE policy, user data from the UE cannot be routed properly when the UE is registered to EPS.

### Solution to Problem

In an aspect of the present disclosure, a method of a User Equipment (UE) includes sending, to a Mobility Management Entity (MME), a first message including information to obtain a UE policy, and receiving, from the MME, a second message including the UE policy.

In an aspect of the present disclosure, a method of a communication apparatus includes receiving, from a User Equipment (UE), a first message including information to obtain a UE policy, sending, to a Serving Gateway (S-GW), a second message including the information, receiving, from the S-GW, a third message including the UE policy, and sending, to the UE, a fourth message including the UE policy, wherein the communication apparatus is a Mobility Management Entity (MME).

In an aspect of the present disclosure, a method of a communication apparatus includes receiving, from a Mobility Management Entity (MME), a first message including information to obtain a UE policy, sending, to a Packet Data Network (PDN) Gateway Control plane function (PGW-C) and Session Management Function (SMF), a second message including the information, receiving, from the PGW-C and SMF, a third message including the UE policy, and sending, to the MME, a fourth message including the UE policy, wherein the communication apparatus is a Serving Gateway (S-GW).

In an aspect of the present disclosure, a method of a communication apparatus includes receiving, from a Serving Gateway (S-GW), a first message including information to obtain a UE policy, sending, to a Policy Control Function (PCF), a second message including the information, receiving, from the PCF, a third message including the UE policy, and sending, to the S-GW, a fourth message including the UE policy, wherein the communication apparatus is a Packet Data Network (PDN) Gateway Control plane function (PGW-C) and Session Management Function (SMF).

In an aspect of the present disclosure, a method of a communication apparatus includes receiving, form a Packet Data Network (PDN) Gateway Control plane function (PGW-C) and Session Management Function (SMF), a first message including information to obtain a UE policy, sending, to a Unified Data Management (UDM) or a Unified Data Repository (UDR), a second message including the information, receiving, from the UDM or the UDR, a third message including the UE policy, and sending, to the PGW-C and SMF, a fourth message including the UE policy, wherein the communication apparatus is a Policy Control Function (PCF).

In an aspect of the present disclosure, a User Equipment (UE) includes means for sending, to a Mobility Management Entity (MME), a first message including information to obtain a UE policy, and means for receiving, from the MME, a second message including the UE policy.

In an aspect of the present disclosure, a communication apparatus includes means for receiving from a User Equipment (UE), a first message including information to obtain a UE policy, means for sending, to a Serving Gateway (S-GW), a second message including the information, means for receiving, from the S-GW, a third message including the UE policy, and means for sending, to the UE, a fourth message including the UE policy, wherein the communication apparatus is a Mobility Management Entity (MME).

In an aspect of the present disclosure, a communication apparatus includes means for receiving, from a Mobility Management Entity (MME), a first message including information to obtain a UE policy, means for sending, to a Packet Data Network (PDN) Gateway Control plane function (PGW-C) and Session Management Function (SMF), a second message including the information, means for receiving, from the PGW-C and SMF, a third message including the UE policy, and means for sending, to the MME, a fourth message including the UE policy, wherein the communication apparatus is a Serving Gateway (S-GW).

In an aspect of the present disclosure, a communication apparatus includes means for receiving, from a Serving Gateway (S-GW), a first message including information to obtain a UE policy, means for sending, to a Policy Control Function (PCF), a second message including the information, means for receiving, from the PCF, a third message including the UE policy, and means for sending, to the S-GW, a fourth message including the UE policy, wherein the communication apparatus is a Packet Data Network (PDN) Gateway Control plane function (PGW-C) and Session Management Function (SMF).

In an aspect of the present disclosure, a communication apparatus includes means for receiving, form a Packet Data Network (PDN) Gateway Control plane function (PGW-C) and Session Management Function (SMF), a first message including information to obtain a UE policy, means for sending, to a Unified Data Management (UDM) or a Unified Data Repository (UDR), a second message including the information, means for receiving, from the UDM or the UDR, a third message including the UE policy, and means for sending, to the PGW-C and SMF, a fourth message including the UE policy, wherein the communication apparatus is a Policy Control Function (PCF).

### BRIEF DESCRIPTION OF DRAWINGS

FIG. 1 is a diagram illustrating a non-roaming architecture for interworking between 5GS and EPC/E-UTRAN (Non-roaming architecture for interworking between 5GS and EPC/E-UTRAN).

FIG. 2 is a signaling diagram of a First example of the First Aspect (UE policy update in the EPS during attach procedure).

FIG. 3 is a signaling diagram of a Second example of the First Aspect (UE policy update in the EPS during an ESM procedure).

FIG. 4 is a signaling diagram of a Third example of the First Aspect (UE policy transmission procedure when the UE is registered to EPS).

FIG. 5 is a signaling diagram of a Fourth example of the First Aspect (EPS UE policy obtained from PCF in 5GS).

FIG. 6 is a diagram illustrating a system overview.

FIG. 7 is a block diagram illustrating a User equipment (UE).

FIG. 8 is a block diagram illustrating an (R)AN node.

FIG. 9 is a diagram illustrating System overview of (R)AN node based on O-RAN architecture.

FIG. 10 is a block diagram illustrating a Radio Unit (RU).

FIG. 11 is a block diagram illustrating a Distributed Unit (DU).

FIG. 12 is a block diagram illustrating a Centralized Unit (CU).

FIG. 13 is a block diagram illustrating an Access and Mobility Management Function (AMF).

FIG. 14 is a block diagram illustrating a Session Management Function (SMF).

FIG. 15 is a block diagram illustrating a User Plane Function (UPF).

FIG. 16 is a block diagram illustrating a Policy Control Function (PCF).

FIG. 17 is a block diagram illustrating an Authentication Server Function (AUSF).

FIG. 18 is a block diagram illustrating a Unified Data Management (UDM).

FIG. 19 is a block diagram illustrating a Network Data Analytics Function (NWDAF).

FIG. 20 is a block diagram illustrating a Network Exposure Function (NEF).

FIG. 21 is a block diagram illustrating a Network Slice Admission Control Function (NSACF).

### DESCRIPTION OF EMBODIMENTS

### Abbreviations

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AMF Access and Mobility Management Function
AMF-G Geographically selected Access and Mobility Management Function
AMF-NG Non-Geographically selected Access and Mobility Management Function
ANDSF Access Network Discovery and Selection Function AS Access Stratum
ATSSS Access Traffic Steering, Switching, Splitting
ATSSS-LL ATSSS Low-Layer
AUSF Authentication Server Function
AUTN Authentication token
BCCH Broadcast Control Channel
BMCABest Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
ESM EPS Session Management
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HPLMN Home Public Land Mobile Network
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In the Middle
MME Mobility Management Entity
MNC Mobile Network Code
MPS Multimedia Priority Service
MPTCP Multi-Path TCP Protocol
N3IWF Non-3GPP Inter Working Function
N3GPP Non-3GPP access
N5CW Non-5G-Capable over WLAN
NAI Network Access Identifier
NAS Non-Access-Stratum
NEF Network Exposure Function
NF Network Function
NGAP Next Generation Application Protocol
NID Network identifier
NPN Non-Public Network
NR New Radio
NRF Network Repository Function
NSI ID Network Slice Instance Identifier
NSSAA Network Slice-Specific Authentication and
Authorization
NSSAAF Network Slice-Specific Authentication and
Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PCO Protocol Configuration Options
PDB Packet Delay Budget
PDR Packet Detection Rule
PDU Protocol Data Unit
PEI Permanent Equipment Identifier
PER Packet Error Rate
PFD Packet Flow Description
PGW Packet Data Network (PDN) Gateway
PGW-C PDN Gateway Control plane function
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QoS Flow Identifier
QoE Quality of Experience
RACS Radio Capabilities Signalling optimisation
(R)AN(Radio) Access Network
RAT Radio Access Technology
RG Residential Gateway
RIM Remote Interference Management
RQA Reflective QoS Attribute
RQI Reflective QoS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
S-GW Serving Gateway
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMFUE radio Capability Management Function
UDM Unified Data Management
UDR Unified Data Repository
UDSF Unstructured Data Storage Function
UE User Equipment
UL Uplink
UL CL Uplink Classifier
UPF User Plane Function
UPSI UE Policy Section Identifier
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited Public Land Mobile Network
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

Each of Aspects and elements included in each Aspects described below may be implemented independently or in combination with any other. These Aspects include novel characteristics different from one another. Accordingly, these Aspects contribute to achieving objects or solving problems different from one another and contribute to obtaining advantages different from one another.

An example object of this disclosure is to provide a method and apparatus that can solve the above problem.

A method of a User Equipment (UE) according to example aspect of this disclosure includes sending an Attach Request message including information to obtain a UE policy for the UE. The method includes receiving an Attach Accept message including the UE policy.

A method of a communication apparatus according to example aspect of this disclosure includes receiving an Attach Request message including information to obtain a UE policy. The method includes sending a Create Session Request message including the information. The method includes receiving a Create Session Response message including the UE policy after sending the Create session Request message. The method includes sending an Attach Accept message including the UE policy.

A method of a communication apparatus according to example aspect of this disclosure includes receiving a Create Session Request message including information to obtain a UE policy. The method includes sending the Create Session Request message. The method includes receiving a Create Session Response message including the UE policy after sending the Create session Request message. The method includes sending the Create Session Response message.

A method of a communication apparatus according to example aspect of this disclosure includes receiving a Create Session Request message including information to obtain a UE policy. The method includes sending a first message including the information. The method includes receiving a second message including the UE policy after sending the first message. The method includes sending a third message including the UE policy.

A method of a communication apparatus according to example aspect of this disclosure includes receiving a first message including information to obtain a UE policy. The method includes sending a second message including the information. The method includes receiving a third message including the UE policy after sending the first message. The method includes sending a fourth message including the UE policy.

A method of a communication apparatus according to example aspect of this disclosure includes receiving a first message including information to obtain a UE policy. The method includes obtaining the UE policy. The method includes receiving a second message including the UE policy.

A method of a communication apparatus according to example aspect of this disclosure includes receiving a first message including information to obtain a UE policy. The method includes obtaining the UE policy. The method includes receiving a second message including the UE policy.

A method of a User Equipment (UE) according to example aspect of this disclosure includes sending a first Evolved Packet System (EPS) session management (SM) message including information to obtain a UE policy for the UE. The method includes receiving a second EPS SM message including the UE policy.

A method of a communication apparatus according to example aspect of this disclosure includes receiving a first Evolved Packet System (EPS) session management (SM) message including information to obtain a UE policy. The method includes sending a second EPS SM message including the information. The method includes receiving a third EPS SM message including the UE policy after sending the second EPS SM message. The method includes sending a fourth EPS SM message including the UE policy.

A method of a communication apparatus according to example aspect of this disclosure includes receiving a first Evolved Packet System (EPS) session management (SM) message including information to obtain a UE policy. The method includes sending a second EPS SM message including the information. The method includes receiving a third EPS SM message including the UE policy after sending the second EPS SM message. The method includes sending a fourth EPS SM message including the UE policy.

A method of a communication apparatus according to example aspect of this disclosure includes receiving a first Evolved Packet System (EPS) session management (SM) message including information to obtain a UE policy. The method includes sending a first message including the information. The method includes receiving a second message including the UE policy after sending the first message. The method includes sending a second EPS SM message including the UE policy.

A method of a User Equipment (UE) according to example aspect of this disclosure includes sending a first Evolved Packet System (EPS) (SM) message including information to obtain a UE policy for the UE. The method includes receiving a message including an indicator indicating that the UE policy is pending. The method includes performing a selection of a cell. The method includes performing a registration procedure to 5G system. The method includes receiving the UE policy after performing the registration procedure.

A method of a communication apparatus according to example aspect of this disclosure includes receiving a first Evolved Packet System (EPS) session management (SM) message including information to obtain a UE policy. The method includes sending a second EPS SM message including the information. The method includes receiving a third EPS SM message including an indicator indicating that the UE policy is pending after sending the second EPS SM message. The method includes sending a message including the indicator.

A method of a communication apparatus according to example aspect of this disclosure includes receiving a first Evolved Packet System (EPS) session management (SM) message including information to obtain a UE policy. The method includes sending a second EPS SM message including the information. The method includes receiving a third EPS SM message including an indicator indicating that the UE policy is pending after sending the second EPS SM message. The method includes sending a fourth EPS SM message including the indicator.

A method of a communication apparatus according to example aspect of this disclosure includes receiving a message including an indicator indicating that a UE policy is pending. The method includes receiving a first Evolved Packet System (EPS) session management (SM) message including information to obtain the UE policy. The method includes sending a second EPS SM message including the indicator.

A method of a communication apparatus according to example aspect of this disclosure includes receiving a first message including a UE policy. The method includes sending a second message including an indicator indicating that the UE policy is pending.

A method of a User Equipment (UE) according to example aspect of this disclosure includes sending a Registration Request message. The Registration Request message includes information indicating that the UE supports reception of a UE policy for Evolved Packet System via 5G system. The method includes receiving the UE policy after sending the Registration Request message.

A method of a communication apparatus according to example aspect of this disclosure includes receiving a Registration Request message from a User Equipment (UE). The Registration Request message includes information indicating that the UE supports reception of a UE policy for Evolved Packet System via 5G system. The method includes sending a message including the information. The method includes receiving the UE policy after sending the message. The method includes sending the UE policy to the UE.

A method of a communication apparatus according to example aspect of this disclosure includes receiving a message. The message includes information indicating that a User Equipment (UE) supports reception of a UE policy for Evolved Packet System via 5G system. The method includes sending the UE policy after receiving the message.

A User Equipment (UE) according to example aspect of this disclosure includes a memory, and at least one hardware processor coupled to the memory. The at least one hardware processor is configured to send an Attach Request message including information to obtain a UE policy for the UE. The at least one hardware processor is configured to receive an Attach Accept message including the UE policy.

A communication apparatus according to example aspect of this disclosure includes a memory, and at least one hardware processor coupled to the memory. The at least one hardware processor is configured to receive an Attach Request message including information to obtain a UE policy. The at least one hardware processor is configured to send a Create Session Request message including the information. The at least one hardware processor is configured to receive a Create Session Response message including the UE policy after sending the Create session Request message. The at least one hardware processor is configured to send an Attach Accept message including the UE policy.

A communication apparatus according to example aspect of this disclosure includes a memory, and at least one hardware processor coupled to the memory. The at least one hardware processor is configured to receive a Create Session Request message including information to obtain a UE policy. The at least one hardware processor is configured to send the Create Session Request message. The at least one hardware processor is configured to receive a Create Session Response message including the UE policy after sending the Create session Request message. The at least one hardware processor is configured to send the Create Session Response message.

A communication apparatus according to example aspect of this disclosure includes a memory, and at least one hardware processor coupled to the memory. The at least one hardware processor is configured to receive a Create Session Request message including information to obtain a UE policy. The at least one hardware processor is configured to send a first message including the information. The at least one hardware processor is configured to receive a second message including the UE policy after sending the first message. The at least one hardware processor is configured to send a third message including the UE policy.

A communication apparatus according to example aspect of this disclosure includes a memory, and at least one hardware processor coupled to the memory. The at least one hardware processor is configured to receive a first message including information to obtain a UE policy. The at least one hardware processor is configured to send a second message including the information. The at least one hardware processor is configured to receive a third message including the UE policy after sending the first message. The at least one hardware processor is configured to send a fourth message including the UE policy.

A communication apparatus according to example aspect of this disclosure includes a memory, and at least one hardware processor coupled to the memory. The at least one hardware processor is configured to receive a first message including information to obtain a UE policy. The at least one hardware processor is configured to obtain the UE policy. The at least one hardware processor is configured to receive a second message including the UE policy.

A communication apparatus according to example aspect of this disclosure includes a memory, and at least one hardware processor coupled to the memory. The at least one hardware processor is configured to receive a first message including information to obtain a UE policy. The at least one hardware processor is configured to obtain the UE policy. The at least one hardware processor is configured to receive a second message including the UE policy.

A User Equipment (UE) according to example aspect of this disclosure includes a memory, and at least one hardware processor coupled to the memory. The at least one hardware processor is configured to send a first Evolved Packet System (EPS) session management (SM) message including information to obtain a UE policy for the UE. The at least one hardware processor is configured to receive a second EPS SM message including the UE policy.

A communication apparatus according to example aspect of this disclosure includes a memory, and at least one hardware processor coupled to the memory. The at least one hardware processor is configured to receive a first Evolved Packet System (EPS) session management (SM) message including information to obtain a UE policy. The at least one hardware processor is configured to send a second EPS SM message including the information. The at least one hardware processor is configured to receive a third EPS SM message including the UE policy after sending the second EPS SM message. The at least one hardware processor is configured to send a fourth EPS SM message including the UE policy.

A communication apparatus according to example aspect of this disclosure includes a memory, and at least one hardware processor coupled to the memory. The at least one hardware processor is configured to receive a first Evolved Packet System (EPS) session management (SM) message including information to obtain a UE policy. The at least one hardware processor is configured to send a second EPS SM message including the information. The at least one hardware processor is configured to receive a third EPS SM message including the UE policy after sending the second EPS SM message. The at least one hardware processor is configured to send a fourth EPS SM message including the UE policy.

A communication apparatus according to example aspect of this disclosure includes a memory, and at least one hardware processor coupled to the memory. The at least one hardware processor is configured to receive a first Evolved Packet System (EPS) session management (SM) message including information to obtain a UE policy. The at least one hardware processor is configured to send a first message including the information. The at least one hardware processor is configured to receive a second message including the UE policy after sending the first message. The at least one hardware processor is configured to send a second EPS SM message including the UE policy.

A User Equipment (UE) according to example aspect of this disclosure includes a memory, and at least one hardware processor coupled to the memory. The at least one hardware processor is configured to send a first Evolved Packet System (EPS) session management (SM) message including information to obtain a UE policy for the UE. The at least one hardware processor is configured to receive a message including an indicator indicating that the UE policy is pending. The at least one hardware processor is configured to perform a selection of a cell. The at least one hardware processor is configured to perform a registration procedure to 5G system. The at least one hardware processor is configured to receive the UE policy after performing the registration procedure.

A communication apparatus according to example aspect of this disclosure includes a memory, and at least one hardware processor coupled to the memory. The at least one hardware processor is configured to receive a first Evolved Packet System (EPS) session management (SM) message including information to obtain a UE policy. The at least one hardware processor is configured to send a second EPS SM message including the information. The at least one hardware processor is configured to receive a third EPS SM message including an indicator indicating that the UE policy is pending after sending the second EPS SM message. The at least one hardware processor is configured to send a message including the indicator.

A communication apparatus according to example aspect of this disclosure includes a memory, and at least one hardware processor coupled to the memory. The at least one hardware processor is configured to receive a first Evolved Packet System (EPS) session management (SM) message including information to obtain a UE policy. The at least one hardware processor is configured to send a second EPS SM message including the information. The at least one hardware processor is configured to receive a third EPS SM message including an indicator indicating that the UE policy is pending after sending the second EPS SM message. The at least one hardware processor is configured to send a fourth EPS SM message including the indicator.

A communication apparatus according to example aspect of this disclosure includes a memory, and at least one hardware processor coupled to the memory. The at least one hardware processor is configured to receive a message including an indicator indicating that a UE policy is pending. The at least one hardware processor is configured to receive a first Evolved Packet System (EPS) session management (SM) message including information to obtain the UE policy. The at least one hardware processor is configured to send a second EPS SM message including the indicator.

A communication apparatus according to example aspect of this disclosure includes a memory, and at least one hardware processor coupled to the memory. The at least one hardware processor is configured to receive a first message including a UE policy. The at least one hardware processor is configured to send a second message including an indicator indicating that the UE policy is pending.

A User Equipment (UE) according to example aspect of this disclosure includes a memory, and at least one hardware processor coupled to the memory. The at least one hardware processor is configured to send a Registration Request message. The Registration Request message includes information indicating that the UE supports reception of a UE policy for Evolved Packet System via 5G system. The at least one hardware processor is configured to receive the UE policy after sending the Registration Request message.

A communication apparatus according to example aspect of this disclosure includes a memory, and at least one hardware processor coupled to the memory. The at least one hardware processor is configured to receive a Registration Request message from a User Equipment (UE). The Registration Request message includes information indicating that the UE supports reception of a UE policy for Evolved Packet System via 5G system. The at least one hardware processor is configured to send a message including the information. The at least one hardware processor is configured to receive the UE policy after sending the message. The at least one hardware processor is configured to send the UE policy to the UE.

A communication apparatus according to example aspect of this disclosure includes a memory, and at least one hardware processor coupled to the memory. The at least one hardware processor is configured to receive a message. The message includes information indicating that a User Equipment (UE) supports reception of a UE policy for Evolved Packet System via 5G system. The at least one hardware processor is configured to send the UE policy after receiving the message.

It is assumed that a User Equipment (UE) knows all network slice(s) available within a cell in a VPLMN when the UE is in CM-IDLE state, CM-CONNECTED state or CM-CONNECTED with RRC Inactive state.

The UE policy in below aspects refers to URSP, ANDSP, V2XP, ProseP. For example, the UE policy in below aspects may include URSP, ANDSP, V2XP, ProseP. The UE policy is sent in the UE policy section management list information element of the Manage UE Policy command message as defined in sub clause D.6.2 of NPL 11.

NPL 10 defines the use of URSP and ANDSP rules in the EPS. The UE in below aspects follows the same procedure of use of URSP and ANDSP as defined in the NPL 10.

In the below aspects the PCF gets policy subscription related information and the latest list of PSIs from the UDR using Nudr_DM_Query service operation (SUPI, Policy Data, UE context policy control data, Policy Set Entry) if either or both are not available and makes a policy decision. When there is change in policy of the UE in the UDR or UDM, the UDR notifies to the PCF with change of the UE policy using the existing message between the UDR and PCF.

In below aspects:

The UPSI list is to transfer from the UE to the PCF a list of UPSIs. This information element is defined in sub clause D.6.4 of NPL 11. The UPSI list may be expressed as a UE policy list in this disclosure.

The purpose of the UE policy classmark information element is to provide the network with information about the UE policy aspects of the UE. This IE is defined in sub clause D.6.5. of NPL 11.

The purpose of the UE OS Id information element is to provide the network with information about the OS of the UE. The IE is defined in the sub clause D.6.6 of NPL 11.

If not operating in SNPN access operation mode, the UE includes the UPSI(s) of the UE policy section(s) which are identified by a UPSI with the PLMN ID part indicating the HPLMN or the selected PLMN available in the UE in the UPSI list IE.

If operating in SNPN access operation mode, the UE includes UPSI(s) of the UE policy section(s) which are identified by a UPSI:
with the PLMN ID part indicating the MCC and MNC of the selected SNPN; and
associated with the NID of the selected SNPN.
available in the UE in the UPSI list IE.

The UE specifies whether the UE supports ANDSP in the UE policy classmark IE; and the UE may include the UE's one or more OS IDs in the UE OS Id IE.

When the PCF or UDR/UDM receives UPSI List IE then the PCR or UDM/UDR will check based on UPSI (or the UPSI list) what the UE policy or policies are currently stored in the UE. If the PCF or UDM/UDR determines that the UE policy stored in the UE is old and needs to be changed, the PCF or UDM/UDR sends UE policy accordingly.

When UE policy classmark indicates UE supports ANDSP, then the PCF or UDR/UDM sends ANDSP policy to the UE in the UE policy.

The PCF or UDM/UDR may send the UE policy e.g. URSP corresponding to the OS ID IE received. There can be different URSPs or ANDSP depending on the OS ID. For Android UE the PCF sends different URSP rules than the UE which has iOS.

In one example the UE sends the UE STATE INDICATION message containing a UPSI List IE, a UE policy classmark or an OS ID IE in the attach request message or PDN connectivity request. The MME when receives this message transparently passed it to the S-GW which sends it to the SMF-C+PGW-C which further passes it to the PCF. In one example the UE STATE INDICATION message is sent in the PCO IE of the PDN connectivity request message which is passed to the SMF+PGW-C in PCO IE via S-GW in an ESM message e.g. Create Session Request message.

In one example the PCF sends the MANAGE UE POLICY COMMAND containing UE policy section management list as defined in the NPL 11 to the PGW-C+SMF node, which sends the MANAGE UE POLICY COMMAND message to the UE in an existing IE (e.g. PCO) an existing session management to the UE via S-GW and MME. When the UE receives the MANAGE UE POLICY COMMAND message. the UE will initiate an existing ESM procedure or a new ESM procedure and the UE sends MANAGE UE POLICY COMPLETE message or MANAGE UE POLICY REJECT message in an existing information element e.g. PCO in an existing ESM message or a new ESM message to the MME. The MME forwards the IE containing MANAGE UE POLICY COMPLETE or MANAGE UE POLICY REJECT message to the SMF+PGW-C via S-GW in an existing session management message. When the SMF+PGW-C receives the MANAGE UE POLICY COMPLETE or MANAGE UE POLICY REJECT message it sends it to the PCF. When the PCF receives MANAGE UE POLICY COMPLETE, the PCF determine that the UE policy is transmitted successfully. When the PCF receives MANAGE UE POLICY REJECT message, it determines that the UE policy update is not successful.

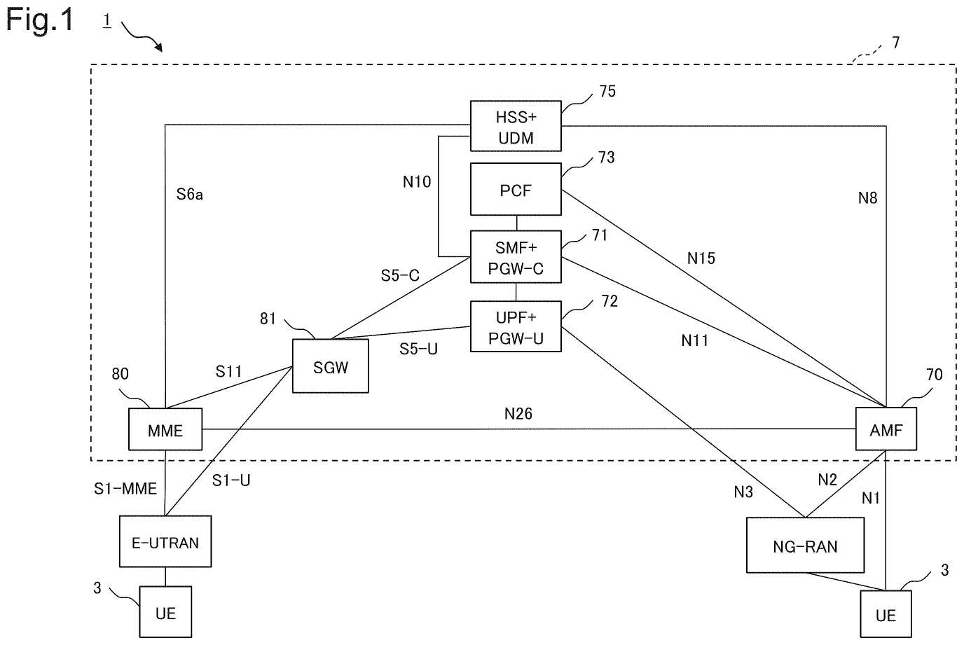

FIG. 1 is a diagram illustrating a non-roaming architecture for interworking between 5GS and EPC/E-UTRAN. In the FIG. 1, a telecommunication system 1 includes UE(s) 3, an E-UTRAN, an NG-RAN, and a core network 7. The core network 7 includes logical nodes (or ‘functions’) for supporting a communication in the telecommunication system 1. More specifically, the core network 7 includes AMF 70, SMF+PGW-C (or PGW-C+SMF) 71, UPF+PGW-U 72, PCF 73, HSS+UDM 75, MME 80, and SGW (or S-GW) 81. SMF+PGW-C 71 has functions of PGW-C in EPC and functions of SMF in 5GC. UPF+PGW-U 72 has functions of PGW-U in EPC and functions of UPF in 5GC. HSS+UDM 75 has functions of HSS in EPC and functions of UDM in 5GC.

N26 interface is an inter-CN interface between the MME 80 and 5GS AMF 70 in order to enable interworking between EPC and the NG core. Support of N26 interface in the network is optional for interworking. N26 supports subset of the functionalities (essential for interworking) that are supported over S10. PGW-C+SMF 71 and UPF+PGW-U 72 are dedicated for interworking between 5GS and EPC, which are optional and are based on UE MM Core Network Capability and UE subscription. UE(s) 3 that are not subject to 5GS and EPC interworking may be served by entities not dedicated for interworking, i.e. by either by PGW or SMF/UPF. There can be another UPF (not shown in the FIG. 1) between the NG-RAN and the UPF+PGW-U 72, i.e. the UPF+PGW-U 72 can support N9 towards an additional UPF, if needed.

Other details of the architecture shown in FIG. 1 are described in NPL 4.

### <First Aspect>

This aspect discloses a method of transmitting the UE policy to a UE 3 when the UE 3 is attached to an EPS.

### First Example of the First Aspect

First example of the First Aspect discloses a method where a PCF 73 sends the UE policy to the UE 3 when the UE 3 is attaching to the EPS and a default PDN connection is being established during an attach procedure. While the default PDN connection is being established, a PGW-C+SMF 71 sends a message requesting the PCF 73 to provide the UE policy to the UE 3. The PCF 73 sends the UE policy to the PGW-C+SMF 71. The PGW-C+SMF 71 sends the UE policy to an S-GW 81 in an existing GTP-C message or in a new GTP-C message. The S-GW 81 sends the UE policy to an MME 80 in an existing GTP-C message or in a new GTP-C message. The MME 80 sends the UE policy either in an existing EPS session management message or in a new EPS session management message or in an existing EPS mobility management message or a new mobility management message. The UE policy is sent as a part of the attach procedure or after the attach procedure when the default PDN connection establishment is finished.

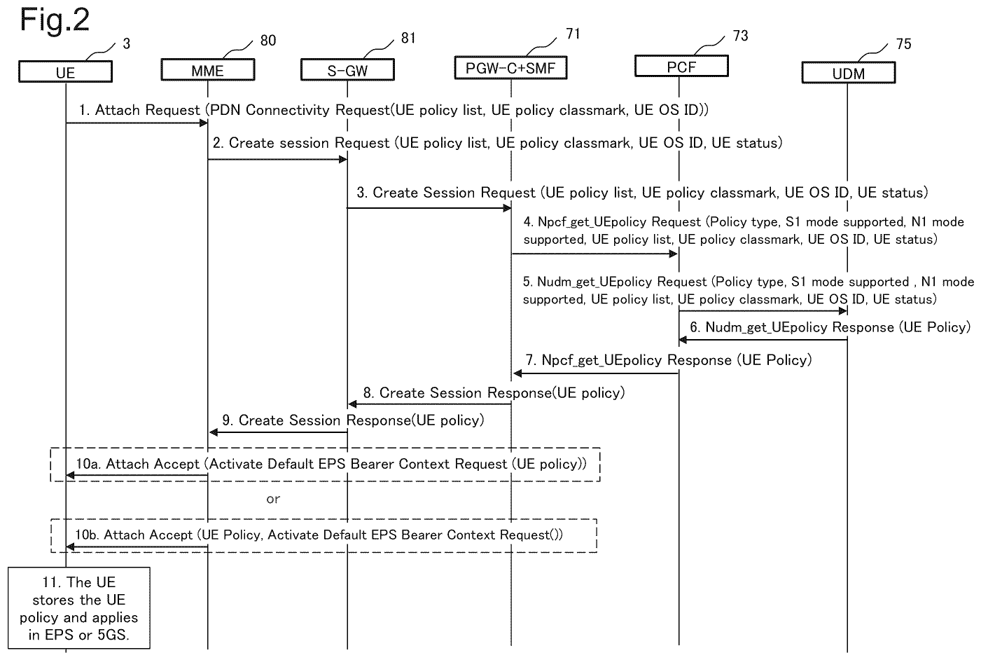

The detailed processes of the First example of the First Aspect are as described below. The detailed processes are shown in the FIG. 2. Hereafter, the UDM 75 may be corresponding to the HSS+UDM 75 in the FIG. 1.

Step 1: The UE 3 initiates attach procedure to a PLMN by sending an attach request message to the MME 80. The UE 3 includes at least one of the UE policy list, UE policy classmark and UE OS ID Information Element (IE) either in a PDN connectivity request message or in the attach request message but not within a PDN connectivity request message. The UE policy list, the UE policy classmark and the UE OS ID Information Element (IE) may be set in the PCO parameter in the attach request message.

Step 2: Upon reception of the attach request message, the MME 80 sends a create session request message containing PCO, UE status and at least one of the UE policy list, the UE policy classmark and the UE OS ID Information Element (IE) to the S-GW 81. The UE status may be added to the create session request message by the MME 80. The UE status may include following information.
CN type: It indicates a CN type, core network type, that the UE 3 is being or has attached. E.g., EPC or 5GC.
Access Type: It indicates an access that the UE 3 is accessing. E.g., 3GPP access or Non-3GPP access.
RAT type: It indicates a Radio Access Technology that the UE 3 is accessing. E.g., EUTRAN, EUTRAN-NB-IoT, LTE-M, or NR.
Permanent Equipment Identifier: E.g., IMEI-SV. Permanent Equipment Identifier may be obtained by the MME 80 by the identity request and identity response procedure as defined in NPL 9.
GPSI.
User Location Information.
UE Time Zone.
Serving Network (PLMN ID, or PLMN ID and NID).

In this disclosure, the MME 80 may determine the UE status based on local information regarding the UE 3 in the MME 80 or received information regarding the UE 3 from other network node(s).

Step 3: Upon reception of the create session request message the S-GW 81 sends the create session request message containing the PCO, the UE status and at least one of the UE policy list, the UE policy classmark and the UE OS ID Information Element (IE) to the PGW-C+SMF 71.

Refer to the step 2 of the FIG. 2 for contents of the UE status. The PGW-C+SMF 71 may be called as a communication apparatus including a PGW-C and SMF.

Step 4: Upon reception of the create session request message the PGW-C+SMF 71 sends an existing message defined between SMF (e.g. PGW-C+SMF 71) and PCF 73 or a new message e.g. Npcf_get_UEpolicy Request message containing at least one of Policy type, S1 mode supported, N1 mode supported, the UE policy list, the UE policy classmark, the UE OS ID IE and the UE status. The Policy type indicates a type of UE policy that the PGW-C+SMF 71 wants to fetch for the UE 3. If at least one of the UE policy list, the UE policy classmark and the UE OS ID Information Element (IE) are encapsulated in the PCO, the PGW-C+SMF 71 extracts at least one of the UE policy list, the UE policy classmark and the UE OS ID Information Element (IE) from the PCO.

In one example when policy list is not contained in the create session request message, the PGW-C+SMF 71 includes Policy type information element. In this disclosure, the PGW-C+SMF 71 may determine the Policy type information element based on the UE policy list. In this disclosure, the PGW-C+SMF 71 may determine the Policy type information element based on a local configuration in the PGW-C+SMF 71 or stored information regarding policy list of the UE 3.

Refer to the step 2 of the FIG. 2 for contents of the UE status.

The information “S1 mode supported” may indicate that the UE 3 supports S1 mode.

The information “N1 mode supported” may indicate that the UE 3 supports N1 mode.

The PGW-C+SMF 71 may obtain at least one of the “S1 mode supported” and the “N1 mode supported” based on information regarding the UE 3 stored in the PGW-C+SMF 71 or received information regarding the UE 3 from other network node(s).

Step 5: Upon reception of the message from the PGW-C+SMF 71, the PCF 73 sends an existing message defined between PCF 73 and UDR or UDM 75 or a new message e.g. Nudm_get_UEpolicy

Request message containing at least one of the Policy type, the S1 mode supported, the N1 mode supported, the UE policy list, the UE policy classmark, the UE OS ID and the UE status to the UDM 75 or UDR.

Refer to the step 2 of the FIG. 2 for contents of the UE status.

Step 6: Upon reception of the message from the PCF 73, the UDR or UDM 75 transfers the UE policy to the PCF 73 in an existing message between UDM 75/UDR and PCF 73 or a new message e.g. an Nudm_get_UEpolicy Response message.

In one example the UDR or UDM 75 sends all UE policy to the PCF 73. For example, the UDR or UDM 75 sends all UE policy for the UE 3 to the PCF 73.

In one example the UDM 75 or UDR sends a UE policy corresponding to the value defined in UE policy type IE or UE policy classmark or UE policy list.

For example, the UDM 75 or UDR may obtain the UE policy corresponding to the value defined in UE policy type IE or UE policy classmark or UE policy list, and send the UE policy.

For example, the UDM 75 or UDR may obtain the UE policy based on the value defined in the UE policy classmark or the UE policy list in the manner mentioned in the General section.

For example, the UDM 75 or UDR may obtain the UE policy corresponding to the Policy type. For example, the UDM 75 or UDR may obtain the UE policy corresponding to a value of the Policy type. The value of the policy type may be URSP, ANDSP, V2XP or ProseP or combinations of the policy type values e.g. URSP and ANDSP.

For example, the UDM 75 or UDR may obtain the UE policy which is appropriate to the UE supporting S1 mode based on the information “S1 mode supported”.

For example, the UDM 75 or UDR may obtain the UE policy which is appropriate to the UE supporting N1 mode based on the information “N1 mode supported”.

For example, the UDM 75 or UDR may obtain the UE policy based on the UE status.

For example, the UDM 75 or UDR may obtain the UE policy which is appropriate in CN indicated by the CN type in the UE status.

For example, the UDM 75 or UDR may obtain the UE policy which is appropriate in the Access type indicated by the UE status.

For example, the UDM 75 or UDR may obtain the UE policy which is appropriate in the RAT type indicated by the UE status.

For example, the UDM 75 or UDR may obtain the UE policy corresponding to the Permanent Equipment Identifier indicated by the UE status.

For example, the UDM 75 or UDR may obtain the UE policy corresponding to the GPSI indicated by the UE status.

For example, the UDM 75 or UDR may obtain the UE policy which is appropriate in a location indicated by the User Location Information in the UE status.

For example, the UDM 75 or UDR may obtain the UE policy which is appropriate in Time Zone (or time, or time period) indicated by the UE Time Zone in the UE status.

For example, the UDM 75 or UDR may obtain the UE policy which is appropriate in a network indicated by the Serving Network in the UE status.

For example, in a case where the UDM 75 or UDR obtains the UE policy, the UDM 75 or UDR may send the obtained UE policy to the PCF 73.

Step 7: Upon reception of the UE policy in the response message from the UDM 75 or UDR, the PCF 73 sends an existing message defined between PCF 73 to SMF or in a new message e.g. Npcf_get_UEpolicy response message to the PGW-C+SMF 71. The existing message or the new message may include the UE policy.

Step 8: Upon reception of the UE policy in the response message from the PCF 73, the PGW-C+SMF 71 sends a Create session response message containing the UE policy to the S-GW 81. The UE policy may be stored in the PCO. The UE policy may be stored in the PCO of the Create session response message.

Step 9: Upon reception of the Create session response message, the S-GW 81 sends a Create session response message containing at least one of the PCO and the UE policy to the MME 80.

Upon reception of the Create session response message the MME 80 takes either step 10a or step 10b.

Step 10a: The MME 80 sends an attach accept message containing at least one of the PCO and Activate Default EPS Bearer Context Request message which contains the UE policy. If the UE policy is encapsulated in the PCO, the UE 3 extracts the UE policy from the PCO.

Step 10b: The MME 80 sends an attach accept message containing at least one of the PCO and the UE policy and an Activate Default EPS Bearer Context Request message.

Step 11: The UE 3 upon reception of the UE policy applies the UE policy when the UE 3 is registered in the EPS or when the UE 3 registers to the 5GS as defined in NPL 10.

In this disclosure, the at least one of the Policy type, the S1 mode supported, the N1 mode supported, the UE policy list, the UE policy classmark, the UE OS ID IE and the UE status may be expressed as information to obtain the UE policy.

According to the above processes, for example the First Example of the First Aspect can provide a procedure for sending the UE policy to the UE when the UE is attached to the EPS.

### Variant 1 of First Example of the First Aspect

The First example of the First Aspect can also take place when the UE 3 performs the Tracking Area Update procedure. In this case, following replacements in the FIG. 2 are needed.
Step 1 is replaced with a TAU request message.
Step 10a is replaced with a TAU accept message.
Step 10b is replaced with a TAU accept message.

### Variant 2 of First Example of the First Aspect

Some messages in the First example of the First Aspect can also take place when the UE policy is updated in the PCF 73. In this case, following replacements and updates in the FIG. 2 are needed. Contents of the replaced messages may be same to the contents of the message in FIG. 2.
Step 7 is triggered when the PCF 73 decides to update the UE Policy in the UE 3.
Step 7 is replaced with an existing message defined between PCF 73 to SMF or in a new message e.g. an Npcf_UEPolicyControl_UpdateNotify message to the PGW-C+SMF 71.
Step 8 is replaced with an Update Bearer Request message.
Step 9 is replaced with an Update Bearer Request message.
Step 10a is replaced with a Bearer Modify Request message.
Step 10b is replaced with a Bearer Modify Request message.
Following steps are added after the step 11.
Step 12: The UE 3 sends a Bearer Modify Response message to the MME 80 indicating that the UE 3 has successfully updated the UE policy.
Step 13: Upon reception of the message in step 12, the MME 80 sends an Update Bearer Response message to the S-GW 81 . . . . Step 14: Upon reception of the message in step 13, the S-GW 81 sends the Update Bearer Response message to the PGW-C+SMF 71.

### Variant 3 of First Example of the First Aspect

At step 1 in FIG. 2, the UE 3 may also indicate its capability for receiving and handling the UE Policy, e.g. the URSP rules while the UE 3 is registered in EPS. For this the UE 3 may include a new ‘UE Policy update in EPS support’ parameter in the Attach Request message to the AMF 70 in step 1. This new parameter may be called ‘UE Policy update in EPS support’ or any other notation for a parameter to indicate the UE 3 capability for receiving and handling the UE Policy, e.g. URSP rules update in the UE while the UE 3 is registered in EPS. This new ‘UE Policy update in EPS support’ parameter may also be indicated from the UE 3 to the AMF 70 in the RA Update procedure or in any other NAS message between the UE 3 and the AMF 70. If the UE 3 included the ‘UE Policy update in EPS support’ parameter in a NAS message to the AMF 70, the AMF 70 retrieves the UE Policy as per steps 2 to 9 in FIG. 2. Also, if the UE 3 included the ‘UE Policy update in EPS support’ parameter in a NAS message to the AMF 70, the AMF 70 includes the UE Policy, i.e. the URSP rules in the Attach Accept message to the UE 3 in step 10 in FIG. 2. The AMF 70 may also use any of the existing NAS messages, including the UE Configuration Update message in order to deliver the UE policy to the UE 3. As soon as the UE 3 receives the UE Policy, e.g. URSP rules, from the network i.e. the AMF 70, the UE 3 stores the UE Policy in the UE 3 and the UE 3 starts applying the new updated UE Policy, e.g. URSP rules.

It should be noted that in one other implementation the ‘UE Policy update in EPS support’ parameter may be represented as a new ‘UE Policy update in EPS support’ field in the UE policy classmark.

### Variant 4 of First Example of the First Aspect

In one example the UE 3 may not send any of the UE policy list, UE policy classmark or UE OS ID Information Element (IE) in attach request message. In this case when the PCF 73 or UDM 75/UDR receives Policy type from PGW-C+SMF 71 then the PCF 73 or UDM 75/UDR sends the UE policy corresponding to the value in the policy type. The value of policy type is URSP, ANDSP, V2XP or ProseP or combinations of the policy type values e.g. URSP and ANDSP.

### Second Example of the First Aspect

Second example of the First Aspect discloses a method where a UE 3 requests a network to send a UE policy during in an ESM message during an ESM procedure, e.g., in a PDN connection request message during standalone PDN connection establishment procedure after the UE 3 is successfully attached to the EPS. On receiving a request from the UE 3 to download the UE policy, the EPS network requests the PCF 73 to send the UE policy. The PCF 73 sends the UE policy to the EPS which in response sends this UE policy to the UE 3 in an ESM message.

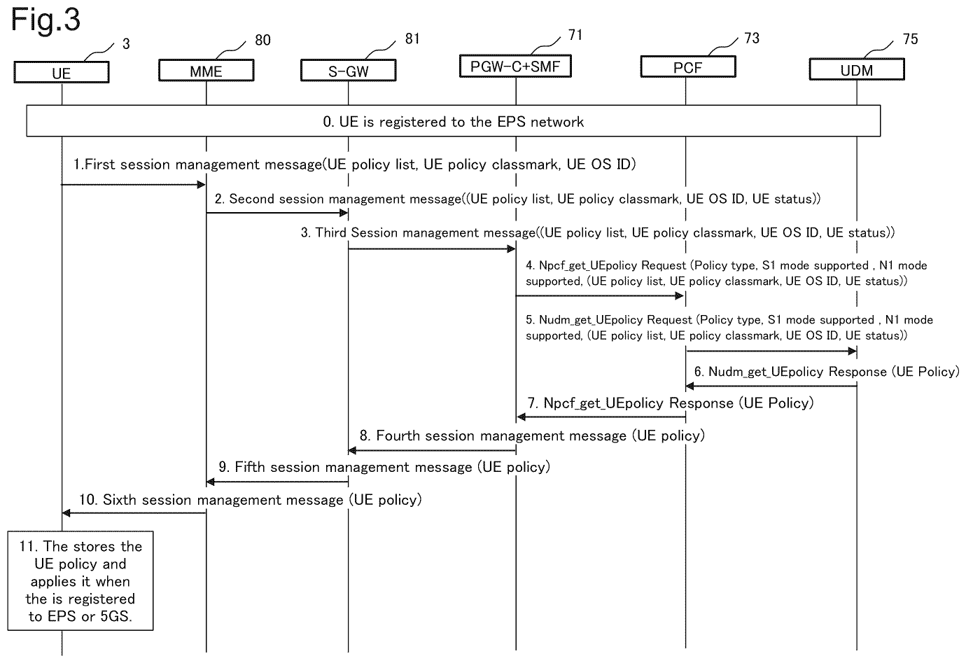

The detailed processes of the Second example of the First Aspect are as described below. The detailed processes are shown in the FIG. 3.

Step 0. The UE 3 is registered to an EPS network as defined in the NPL 8.

Step 1. The UE 3 initiates an ESM procedure, e.g., a standalone PDN connection establishment procedure, or UE requested bearer resource allocation procedure. The UE 3 sends a first ESM message e.g., a PDN connectivity request message containing at least one of UE policy list, UE policy classmark and UE OS ID Information Element (IE). The UE policy list, the UE policy classmark and the UE OS ID Information Element (IE) may be set in a PCO parameter in the first ESM message.

Step 2: Upon reception of the first ESM message, the MME 80 sends a second ESM message containing the PCO, UE status and at least one of the UE policy list, the UE policy classmark and the UE OS ID Information Element (IE) to the S-GW 81. The UE status may be added to the second ESM message by the MME 80.

Refer to the step 2 of the FIG. 2 for contents of the UE status.

Step 3: Upon reception of the second ESM message, the S-GW 81 sends a third ESM message e.g., a Create session request message containing the PCO, the UE status and at least one of the UE policy list, the UE policy classmark and the UE OS ID Information Element (IE) to the PGW-C+SMF 71.

Refer to the step 2 of the FIG. 2 for contents of the UE status.

Step 4: The PGW-C+SMF 71 sends an existing message defined between SMF and PCF 73 or a new message e.g. an Npcf_get_UEpolicy Request message containing at least one of Policy type, S1 mode supported, N1 mode supported, the UE policy list, the UE policy classmark, the UE OS ID IE and the UE status. The Policy type indicates a type of the UE policy that the PGW-C+SMF 71 wants to fetch for the UE 3. If at least one of the UE policy list, the UE policy classmark and the UE OS ID Information Element (IE) are encapsulated in the PCO, the PGW-C+SMF 71 extracts at least one of the UE policy list, the UE policy classmark and the UE OS ID Information Element (IE) from the PCO.

Refer to the step 2 of the FIG. 2 for contents of the UE status.

In one example when the UE policy list is not contained in the third ESM message (e.g. the Create session request message), the PGW-C+SMF 71 includes the Policy type information element.

Step 5: Upon reception of the message from the PGW-C+SMF 71, the PCF 73 sends an existing message defined between PCF 73 and UDR or UDM 75 or a new message e.g. an Nudm_get_UEpolicy Request message containing at least one of the Policy type, the S1 mode supported, the N1 mode supported, the UE policy list, the UE policy classmark, the UE OS ID and the UE status to the UDM 75 or UDR.

Step 6: Upon reception of the message from the PCF 73, the UDR or the UDM 75 transfers the UE policy to the PCF 73 in an existing message between UDM 75/UDR and PCF 73 or a new message e.g. an Nudm_get_UEpolicy Response message.

In one example the UDR or UDM 75 sends all UE policy to the PCF 73. For example, the UDR or UDM 75 sends all UE policy for the UE 3 to the PCF 73.

In one example the UDM 75 or UDR sends a UE policy corresponding to the value defined in the UE policy type IE or the UE policy classmark or the UE policy list.

For example, the UDM 75 or UDR may obtain and send the UE policy in the same manner as step 6 in FIG. 2.

Step 7: Upon reception of the UE policy in the response message from the UDM 75 or UDR, the PCF 73 sends an existing message defined between PCF 73 to SMF or in a new message e.g., an Npcf_get_UEpolicy response message to the PGW-C+SMF 71. The existing message or the new message includes the UE policy.

Step 8: Upon reception of the UE policy in the response message from the PCF 73, the PGW-C+SMF 71 sends a fourth ESM message e.g., a Create session response message containing the UE policy to the S-GW 81. The UE policy may be stored in the PCO. The UE policy may be stored in the PCO of the fourth ESM message.

Step 9: Upon reception of the fourth ESM message e.g. the Create session response message, the S-GW 81 sends a fifth ESM message e.g. a Create session response message containing the UE policy to the MME 80. The UE policy may be stored in the PCO. The UE policy may be stored in the PCO of the fifth message.

Step 10: Upon reception of the fifth ESM message e.g., the Create session response message, the MME 80 sends a sixth message e.g., an Activate Default EPS Bearer Context Request message which contains the UE policy. The UE policy may be stored in the PCO. If the UE policy is encapsulated in the PCO, the UE 3 extracts the UE policy from the PCO.

Step 11: the UE 3 upon reception of the UE policy, applies UE policy when the UE 3 is registered in the EPS or when the UE 3 registers to the 5GS as defined in NPL 10.

According to the above processes, for example the Second example of the First Aspect can provide a procedure for sending the UE policy to the UE 3 when the UE 3 is attached to the EPS.

### Variant 1 of Second Example of the First Aspect

At step 1 in FIG. 3, the UE 3 may also indicate its capability for receiving and handling the UE Policy, e.g. the URSP rules while the UE 3 is registered in EPS. For this the UE 3 may include a new ‘UE Policy update in EPS support’ parameter in the First session management message to the AMF 70 in step 1. This new parameter may be called ‘UE Policy update in EPS support’ or any other notation for a parameter to indicate the UE 3 capability for receiving and handling the UE Policy, e.g. URSP rules update in the UE while the UE 3 is registered in EPS. If the UE 3 included the ‘UE Policy update in EPS support’ parameter in the First session management message to the AMF 70, the AMF 70 retrieves the UE Policy as per steps 2 to 9 in FIG. 3. Also, if the UE 3 included the ‘UE Policy update in EPS support’ parameter in the First session management message to the AMF 70 in step 1, the AMF 70 includes the UE Policy, i.e. the URSP rules in the Session management message in step 10 of FIG. 3. As soon as the UE 3 receives the UE Policy, e.g. URSP rules, from the network i.e. the AMF 70, the UE 3 stores the UE Policy in the UE 3 and the UE 3 starts applying the new updated UE Policy, e.g. URSP rules.

### Variant 2 of Second Example of the First Aspect

In one example the UE 3 may not send any of the UE policy list, UE policy classmark or UE OS ID Information Element (IE) in the first session management message. In this case when the PCF 73 or UDM 75/UDR receives Policy type from PGW-C+SMF 71 then the PCF 73 or UDM 75/UDR sends the UE policy corresponding to the value in the policy type. The value of policy type is URSP, ANDSP, V2XP or ProseP or combinations of the policy type values e.g. URSP and ANDSP.

### Third Example of the First Aspect

Third example of the First Aspect discloses a method where a PCF 73 indicates to the PGW-C+SMF 71 that UE policy update is pending. The PGW-C+SMF 71 sends an indication to the UE 3 in ESM message via S-GW 81 and MME 80 that the user policy update (e.g. the UE policy update) is pending. When the UE 3 receives the indication that the user policy update is pending then the UE 3 selects NG-RAN cell(s) even though the cell (re) selection criteria satisfies to camp on an E-UTRAN cell connected to EPS. After selecting the NG-RAN cell(s), the UE 3 registers to the 5GS. The PCF 73 transmits the UE policy to the UE 3 as defined in the NPL 11 after successful registration to the 5GS. The UE 3 stays registered to the 5GS until the UE 3 receives the UE policy. The UE 3 stores the UE policy and applies the UE policy while the UE 3 is registered to 5GS or EPS. After receiving the UE policy, the UE 3 may apply cell reselection criteria and may choose E-UTRAN cell connected to EPS and registers to the EPS and applies the UE policy in the EPS.

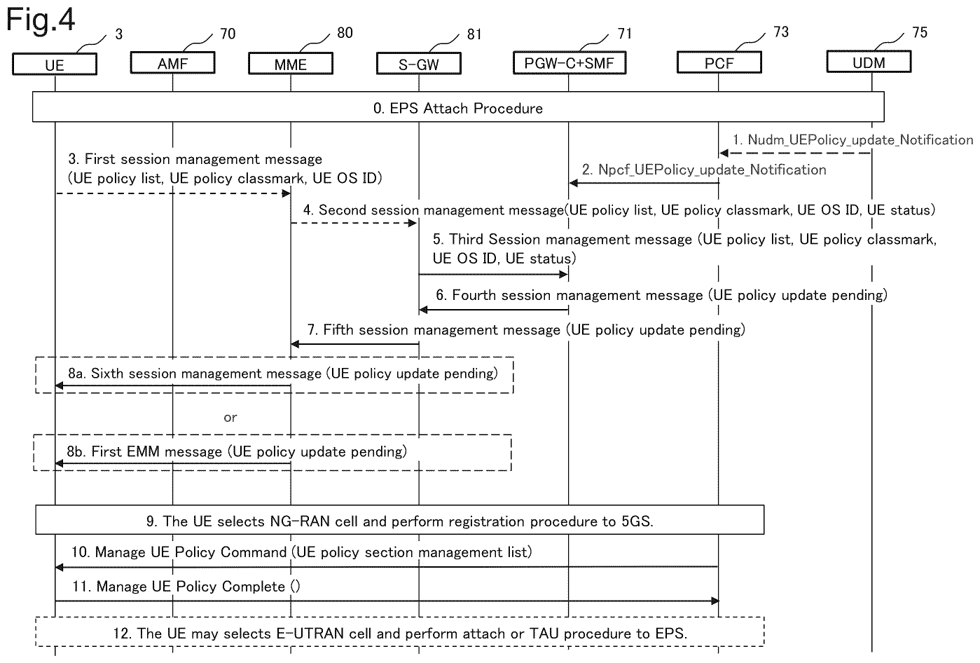

The detailed processes of the Third example of the First Aspect are as described below. The detailed processes are shown in the FIG. 4.

Step 0. The UE 3 registers (or attaches) to the EPS as defined in NPL 8.

In one example the UE 3 and network may follow steps 1-6 in the First example of the First aspect.

Step 1: When a UDM 75 determines to update a UE policy (e.g. a UE policy for the UE 3), the UDM 75 sends an existing message or a new message between the UDM 75 or UDR and a PCF 73 containing the UE policy. The UDM 75 may send an Nudm_UEPolicy_update_Notification message containing the UE policy.

Step 2: When the PCF 73 determines e.g., when the PCF 73 receives the updated UE policy from the UDM 75 or the PCF 73 determines by itself e.g., based on the current network condition or operator policy, to update the UE policy and the UE 3 is registered to the EPS, the PCF 73 sends an existing message or a new message containing an indicator indicating that the UE policy update is pending to the PGW-C+SMF 71. The PCF 73 may that the UE 3 is registered to the EPS based on local information regarding a registration status of the UE 3 or based on received information regarding the registration status of the UE 3 from other network node(s). The indicator that the UE policy update is pending may be expressed as a UE policy pending indicator.

Step 3. While the PGW-C+SMF 71 stores the UE policy pending indicator for the UE 3, the UE 3 may initiate an ESM procedure, e.g., a standalone PDN connection establishment procedure, or a UE requested bearer resource allocation procedure. The UE 3 sends a first ESM message e.g., a PDN connectivity request message containing at least one of UE policy list, UE policy classmark and UE OS ID Information Element (IE). The UE policy list, the UE policy classmark and the UE OS ID Information Element (IE) may be set in the PCO parameter in the first ESM message.

Step 4: Upon reception of the first ESM message, the MME 80 sends a second ESM message containing the PCO, UE status and at least one of the UE policy list, the UE policy classmark and the UE OS ID Information Element (IE) to the S-GW 81. The UE status may be added to the first ESM message by the MME 80.

Refer to the step 2 of the FIG. 2 for contents of the UE status.

Step 5: Upon reception of the second ESM message, the S-GW 81 sends a third ESM message e.g. a Create session request message containing the PCO, the UE status and at least one of the UE policy list, the UE policy classmark and the UE OS ID Information Element (IE) to the PGW-C+SMF 71.

Refer to the step 2 of the FIG. 2 for contents of the UE status.

Step 6: Upon reception of the third ESM message, the PGW-C+SMF 71 sends a fourth ESM message e.g., a Create session response message containing an indicator indicating that the UE policy is pending (e.g. the UE policy pending indicator for the UE 3) to the S-GW 81. The indicator may be stored in the PCO. The indicator may be stored in the PCO of the fourth ESM message. The PGW-C+SMF 71 may clear (or delete) the indicator for the UE 3 after the PGW-C+SMF 71 sent the third ESM message with the indicator to the S-GW 81.

Step 7: Upon reception of the fourth ESM message e.g. the Create session response message, the S-GW 81 sends a fifth ESM message e.g. a Create session response message containing the PCO and the indicator indicating that the UE policy is pending to the MME 80. Upon reception of the fourth ESM message the MME 80 takes either step 8a or step 8b.

Step 8a: Upon reception of the fifth ESM message e.g., the Create session response message, the MME 80 sends a sixth ESM message containing the PCO and the indicator indicating that the UE policy is pending e.g., Activate Default EPS Bearer Context Request message. If the indicator is encapsulated in the PCO, the UE 3 extracts the indicator from the PCO. The sixth ESM message may include the UE policy.

Step 8b: Upon reception of the fifth ESM message e.g., the Create session response message, the MME 80 sends a first EMM message containing the PCO and the indicator indicating that the UE policy is pending e.g., Downlink NAS Transport message, EMM information message or EMM STATUS message. If the indicator is encapsulated in the PCO, the UE 3 extracts the indicator from the PCO. The first EMM message may include the UE policy. The indicator indicating that the UE policy is pending may be expressed as an indicator indicating that the user policy update is pending.

Step 9: When the UE 3 receives the indicator indicating that the user policy update is pending then the UE 3 selects a NG-RAN cell even though the cell (re) selection criteria satisfies to camp on a E-UTRAN cell connected to EPS. After selecting the NG-RAN cell, the UE 3 registers to the 5GS. The AMF notifies to the PCF 73 that the UE 3 is registered to the 5GS.

Step 10: The PCF 73 sends a Manage UE policy command message containing the UE policy section management list to the UE 3 as defined in the NPL 11. For example, the PCF 73 may send the Manage UE policy command message in a case where the AMF notifies to the PCF 73 that the UE 3 is registered to the 5GS.

Step 11: Upon reception of the Manage UE policy command message, the UE 3 stores the UE policy section management list and the UE 3 sends the Manage UE policy complete message to the PCF 73. The UE policy section management list may contain the UE policy.

Step 12: Upon (re) selection of the E-UTAN cell and performing the attach procedure to the EPS, the UE 3 may apply the UE policy stored in the step 11 while the UE 3 is attached to the EPS. For example, the UE 3 may (re) select the E-UTRAN cell after receiving the Manage UE Policy Command message or after sending the Manage UE Policy Complete message, then the UE may apply the UE policy stored in the step 11 while the UE 3 is attached to the EPS.

According to the above processes, for example the Third example of the First Aspect can provide a procedure for sending the UE policy to the UE 3 when the UE 3 is attached to the EPS.

### Variant 1 of Third Example of the First Aspect

When the PCF 73 receives the Manage UE policy complete message from the UE 3 in step 11, the PCF 73 may send an existing message or a new message containing an indicator that instructs the PGW-C+SMF 71 to clear a UE policy update pending status for the UE 3.

After the PGW-C+SMF 71 has cleared the UE policy update pending status for the UE 3, the PGW-C+SMF 71 sends an existing message or a new message indicating an acknowledgment of clearing the UE policy update pending status for the UE 3.

For example, after the PGW-C+SMF 71 sends the fourth ESM message containing the indicator indicating that the UE policy is pending, the PGW-C+SMF 71 may store status information indicating that the UE policy for the UE 3 is pending. The status information may be expressed as the UE policy update pending status for the UE 3. Then the PGW-C+SMF 71 may clear the UE policy update pending status for the UE 3 in a case where the PGW-C+SMF 71 receives the existing message or the new message containing the indicator that instructs the PGW-C+SMF 71 to clear a UE policy update pending status for the UE 3.

### Variant 2 of Third Example of the First Aspect

In one example the UE 3 may not send any of the UE policy list, UE policy classmark or UE OS ID Information Element (IE) in the first session management message. In this case when the PCF 73 or UDM 75/UDR receives Policy type from PGW-C+SMF 71 then the PCF 73 or UDM 75/UDR sends the UE policy corresponding to the value in the policy type. The value of policy type is URSP, ANDSP, V2XP or ProseP or combinations of the policy type values e.g. URSP and ANDSP.

### Fourth Example of the First Aspect

Fourth Example of the First Aspect discloses a method where the PCF 73 sends the EPS specific UE policy to a UE 3 when the UE 3 registers to the 5GS.

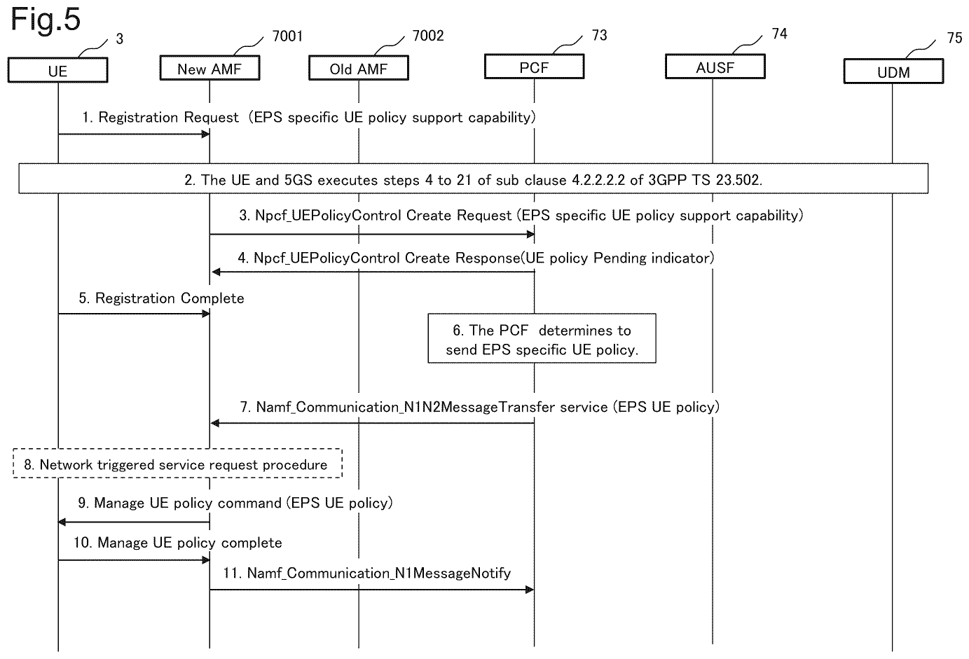

The detailed processes of the Fourth example of the First Aspect are as described below. The detailed processes are shown in the FIG. 5. Hereafter, each of the New AMF 7001 and Old AMF 7002 may be corresponding to the AMF 70 in FIG. 1.

Step 1. When the UE 3 is camped on a NG-RAN cell, the UE 3 may initiate a registration procedure with the cell by sending a Registration Request message to the New AMF 7001 containing EPS specific UE policy support capability. The EPS specific UE policy support capability indicates that the UE 3 supports reception of an EPS UE policy via 5GS. The EPS UE policy may be a UE policy used in the EPS or a UE policy for the EPS. The EPS UE policy may be called as an EPS specific UE policy.

Step 2: The UE 3 and the 5GS perform steps 4-21 of the registration procedure defined in NPL 5.

Step 3. The New AMF 7001 sends an Npcf_UEPolicyControl Create Request including the EPS specific UE policy support capability to the PCF 73. The EPS specific UE policy support capability may be expressed as EPS specific UE policy support capability information element.

Step 4. The PCF 73 stores the EPS specific UE policy support capability information element. Then the PCF 73 sends an Npcf_UEPolicyControl Create Response message to the New AMF 7001. A UE policy Pending indicator may be included in the Npcf_UEPolicy Control Create Response message in a case where the PCF 73 needs to send a UE policy information (or a UE policy) to the UE 3. The UE policy information may be the EPS specific UE policy. The UE policy Pending indicator may be an indicator indicating that the UE policy (e.g. the EPS specific UE policy) is pending.

If the New AMF 7001 receives the UE policy Pending indicator, the New AMF 7001 does not release the N1 connection as new NAS message needs to be sent to the UE 3 after the step 4.

Note that if the UE 3 and the New AMF 7001 maintain the N1 connection after the step 4, the Manage UE policy command message at step 9 can be sent from the New AMF 7001 to the UE 3 without taking the step 8 as the UE 3 does not become to the 5GMM-IDLE state.

Step 5: The UE 3 sends Registration Complete message to the New AMF 7001.

Step 3-4 and step 5 may take place in any order.

Step 6-7: The PCF 73 determines sending the EPS specific UE policy to the UE 3 as the UE 3 supports receiving the EPS specific UE policy via 5GS according to the capability that is received in 3. Then, the PCF 73 sends an step Namf_Communication_N1N2Message Transfer service message including the EPS UE policy.

Step 8: Upon reception of the Namf_Communication_N1N2Message Transfer service message including the EPS UE policy, the New AMF 7001 initiates the network-initiated service request procedure if the UE 3 is 5GMM-IDLE state.

Step 9: The New AMF 7001 sends a Manage UE policy command message to the UE 3 containing the EPS UE policy.

Step 10: Upon reception of the Manage UE policy command message. The UE 3 stores the EPS UE policy and sends a Manage UE policy complete message to the New AMF 7001. The UE 3 uses the EPS UE policy when the UE 3 attaches to the EPS.

Step 11: Upon reception of the Manage UE policy complete message, the New AMF 7001 sends an Namf_Communication_N1MessageNotify message to the PCF 73.

According to the above processes, for example the Fourth Example of the First Aspect can provide a procedure for sending the UE policy (e.g. the UE policy used in the EPS) to the UE 3.

### First Variant of Fourth Example of the First Aspect

In one example the registration request message contains an indicator indicating the UE capability to support UE policy update procedure via EPS. The AMF 70 (e.g. the New AMF 7001) sends the indicator to the PCF 73 or UDM 75 or UDR during the registration procedure as defined in sub clause 4.2.2.2.2 of NPL 5. The PCF 73 or UDM 75/UDR stores this indicator. When the UE 3 register to the EPS, then the PCF 73 or UDR/UDM 75 may trigger UE policy update using the embodiments defined in this disclosure. The indicator is also sent to the PGW-C+SMF 71 during an existing 5GSM procedure e.g. PDU session establishment procedure in an existing 5GSM message in an existing information element or a new information element. The PGW-C+SMF 71 sends the indicator to the PCF 73 or the UDM 75 or UDR.

### <System Overview>

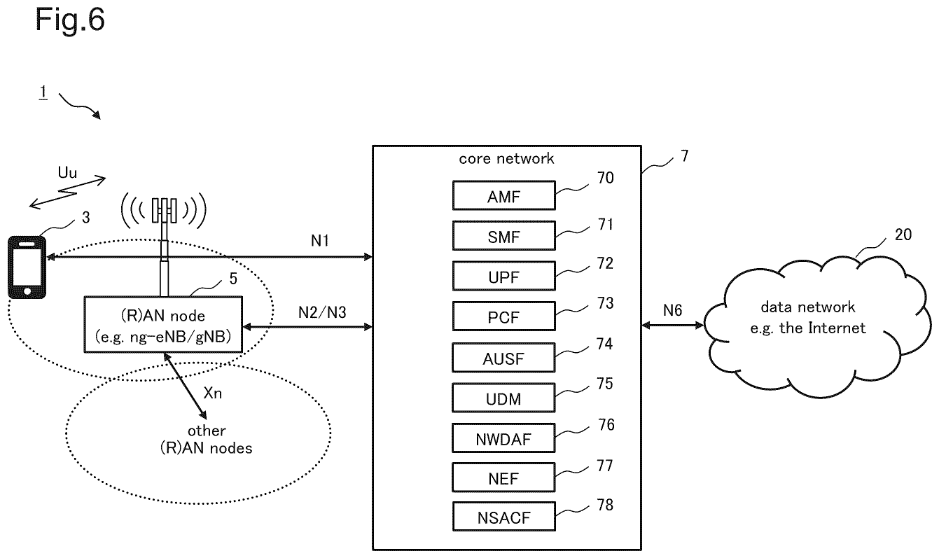

FIG. 6 schematically illustrates a telecommunication system 1 for a mobile (cellular or wireless) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU). In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into control plane function and user plane function. Further, multiple user plane functions can be allocated to support a communication. In some aspects, user traffic may be distributed to multiple user plane functions and user traffic over each user plane functions are aggregated in both the UE 3 and the (R)AN node 5. This split architecture may be called as ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in logical nodes can be considered as a network function. The network function may be provided to another node by adapting the Service Based Architecture (SBA).

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1. In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, an Authentication Server Function (AUSF) 74, a Unified Data Management (UDM) 75, a Network Data Analytics Function (NWDAF) 76, a Network Exposure Function (NEF) 77, and a Network Slice Admission Control Function (NSACF) 78. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN node 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPv6, IPv4v6, Ethernet or unstructured data type.

The “Uu” interface may include a Control plane of Uu interface and User plane of Uu interface.

The User plane of Uu interface is responsible to convey user traffic between the UE 3 and a serving (R)AN node 5. The User plane of Uu interface may have a layered structure with SDAP, PDCP, RLC and MAC sublayer over the physical connection.

The Control plane of Uu interface is responsible to establish, modify and release a connection between the UE 3 and a serving (R)AN node 5. The Control plane of Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, following parameters may be included together in the RRC Setup Request message.
establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, following parameters may be included together in the RRC Setup message.
masterCellGroup and radioBearerConfig
RRC setup complete message: This message is sent from the UE 3 to the (R)AN node 5. In addition to the parameters that are disclosed by Aspects in this disclosure, following parameters may be included together in the RRC setup complete message.
guami-Type, iab-NodeIndication, idleMeasAvailable, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible to provide a communication between the UE 3 and the AMF 70 to support NAS signaling. The N1 interface may be established over a 3GPP access and over a non-3GPP access. For example, the following messages are communicated over the N1 interface.
registration request message: This message is sent from the UE 3 to the AMF 70. In addition to the parameters that are disclosed by Aspects in this disclosure, following parameters may be included together in the registration request message.
5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
registration accept message: This message is sent from the AMF 70 to the UE 3. In addition to the parameters that are disclosed by Aspects in this disclosure, following parameters may be included together in the registration accept message.
5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, following parameters may be included together in the Registration Complete message.
SOR transparent container.
Authentication Request message: This message is sent from the AMF 70 to the UE 3. In addition to the parameters that are disclosed by Aspects in this disclosure, following parameters may be included together in the Authentication Request message.
ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, following parameters may be populated together in the Authentication Response message. Authentication response message identity,
Authentication response parameter and EAP message.
Authentication Result message: This message is sent from the AMF 70 to the UE 3. In addition to the parameters that are disclosed by Aspects in this disclosure, following parameters may be populated together in the Authentication Result message.
ngKSI, EAP message and ABBA.
Authentication Failure message: This message is sent from the UE 3 to the AMF 70. In addition to the parameters that are disclosed by Aspects in this disclosure, following parameters may be populated together in the Authentication Failure message.
Authentication failure message identity, 5GMM cause and Authentication failure parameter.
Authentication Reject message: This message is sent from the AMF 70 to the UE 3. In addition to the parameters that are disclosed by Aspects in this disclosure, following parameters may be populated together in the Authentication Reject message.
EAP message.
Service Request message: This message is sent from the UE 3 to the AMF 70. In addition to the parameters that are disclosed by Aspects in this disclosure, following parameters may be populated together in the Service Request message.
ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, following parameters may be populated together in the Service Accept message.
PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, following parameters may be populated together in the Service Reject message.
5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, following parameters may be populated together in the Configuration Update Command message.
Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, following parameters may be populated together in the Configuration Update Complete message.
Configuration update complete message identity.

### <User Equipment (UE)>

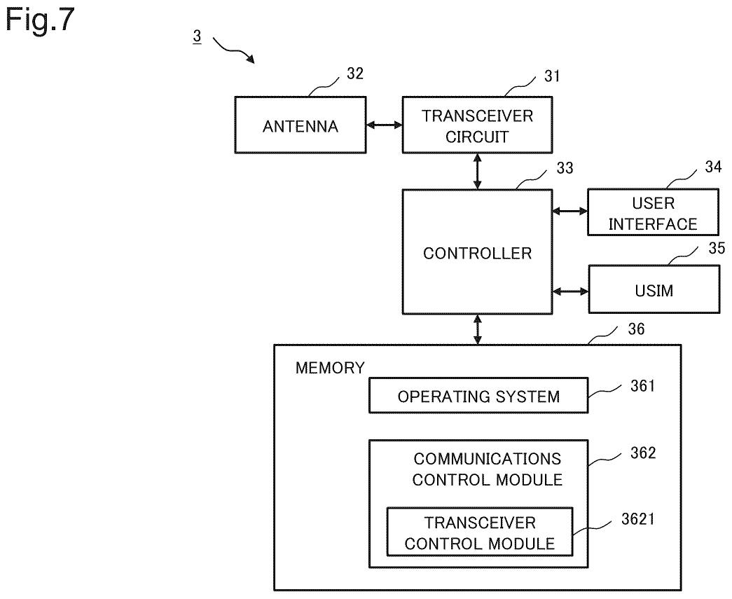

FIG. 7 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (RMD), for example. A controller 33 controls the operation of the UE 3 in accordance with software stored in a memory 36. The software includes, among other things, an operating system 361 and a communications control module 362 having at least a transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 70. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers: engines: turbines: solar panels: wind turbines: hydroelectric generators: thermal power generators: nuclear electricity generators: batteries: nuclear systems and/or associated equipment: heavy electrical machinery: pumps including vacuum pumps: compressors: fans: blowers: oil hydraulic equipment: pneumatic equipment: metal working machinery: manipulators: robots and/or their application systems: tools: molds or dies: rolls: conveying equipment: elevating equipment: materials handling equipment: textile machinery: sewing machines: printing and/or related machinery: paper converting machinery: chemical machinery: mining and/or construction machinery and/or related equipment: machinery and/or implements for agriculture, forestry and/or fisheries: safety and/or environment preservation equipment: tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment; sonic equipment; electromagnetic application equipment: electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### < (R)AN Node>

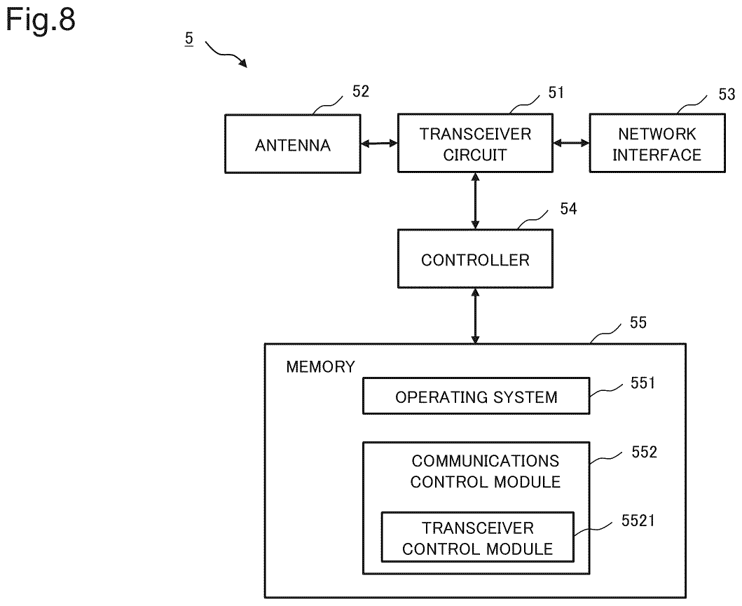

FIG. 8 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (RMD), for example. The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimate and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node Based on O-RAN Architecture>

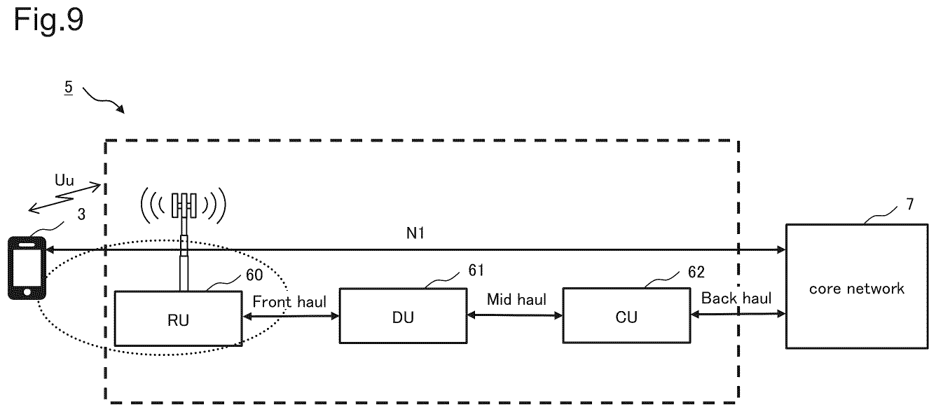

FIG. 9 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide functionalities to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

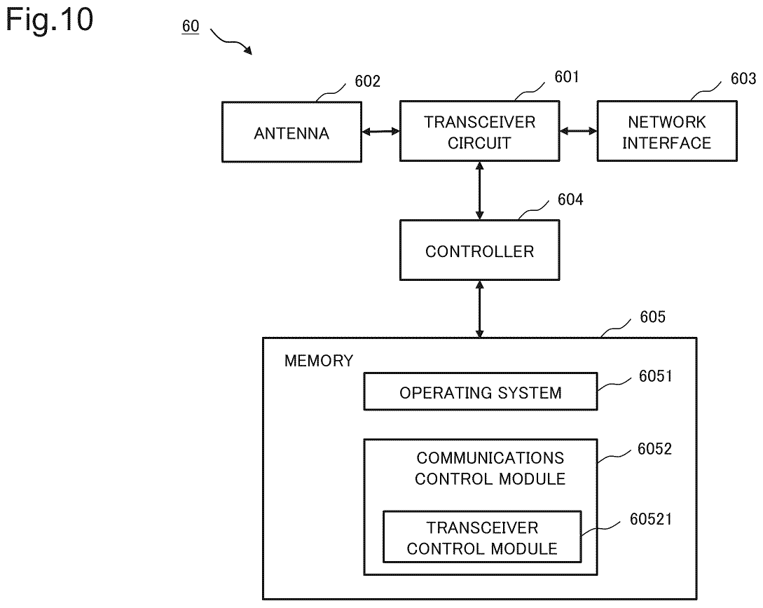

FIG. 10 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (RMD), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimate and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

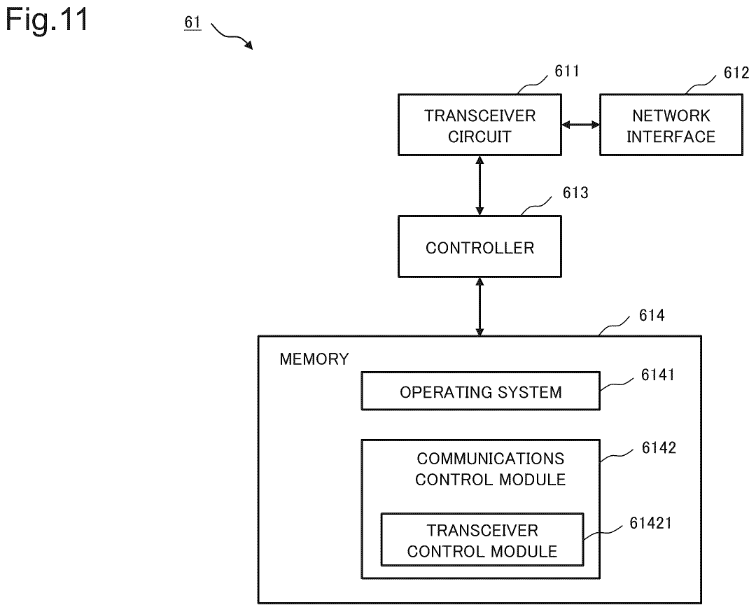

FIG. 11 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612. A controller 613 controls the operation of the DU 61 in accordance with software stored in a memory 614. Software may be pre-installed in the memory 614 and/or may be downloaded via the telecommunication network or from a removable data storage device (RMD), for example. The software includes, among other things, an operating system 6141 and a communications control module 6142 having at least a transceiver control module 61421. The communications control module 6142 (using its transceiver control responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 or CU 62 as an integrated/combined unit. Any functionality in the description for DU 61 can be implemented in one of the integrated/combined unit above.

### <Centralized Unit (CU)>

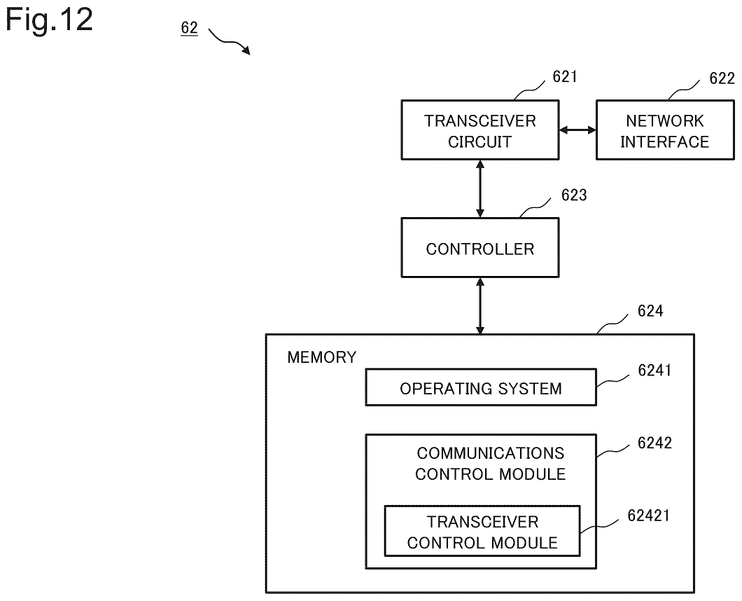

FIG. 12 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622. A controller 623 controls the operation of the CU 62 in accordance with software stored in a memory 624. Software may be pre-installed in the memory 624 and/or may be downloaded via the telecommunication network or from a removable data storage device (RMD), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

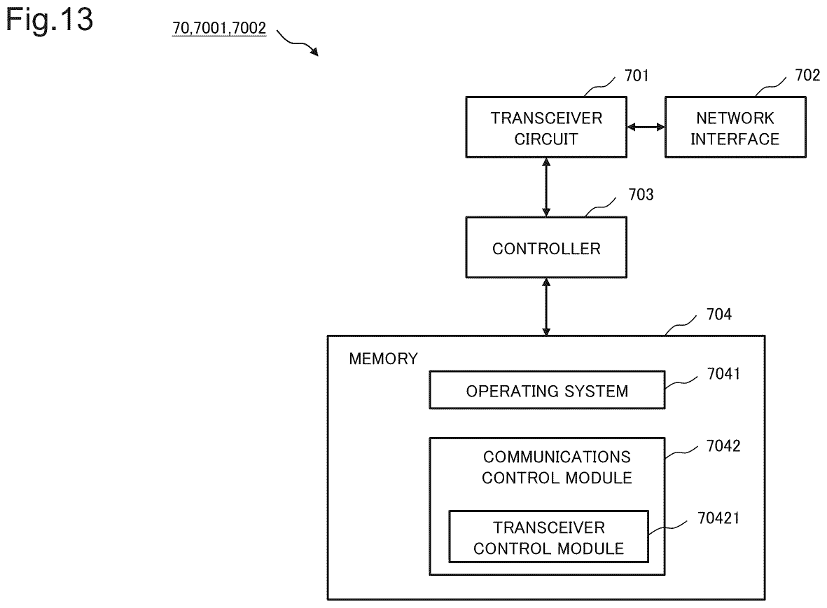

FIG. 13 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (RMD), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3)

The AMF 70 may support the Non-Public Network (NPN), The NPN may be a Stand-alone Non-Public Network (SNPN) or a Public Network Integrated NPN (PNI-NPN).

The New AMF 7001 may have same components to the AMF 70. The Old AMF 7002 may have same components to the AMF 70.

### <SMF>

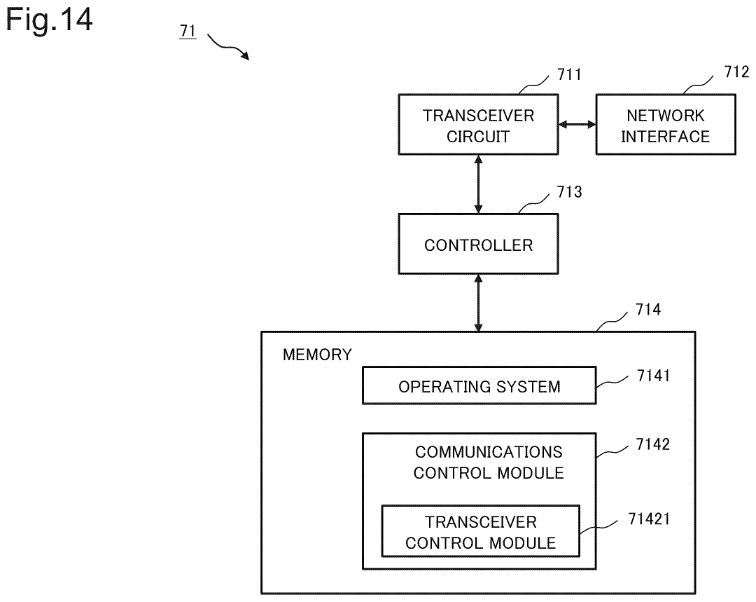

FIG. 14 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable memory device (RMD), for example. The software includes, among other things, an operating system 7141 and a communications control module 7142 having at least a transceiver control module 71421. The communications control module 7142 (using its transceiver control module 71421 is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

### <UPF>

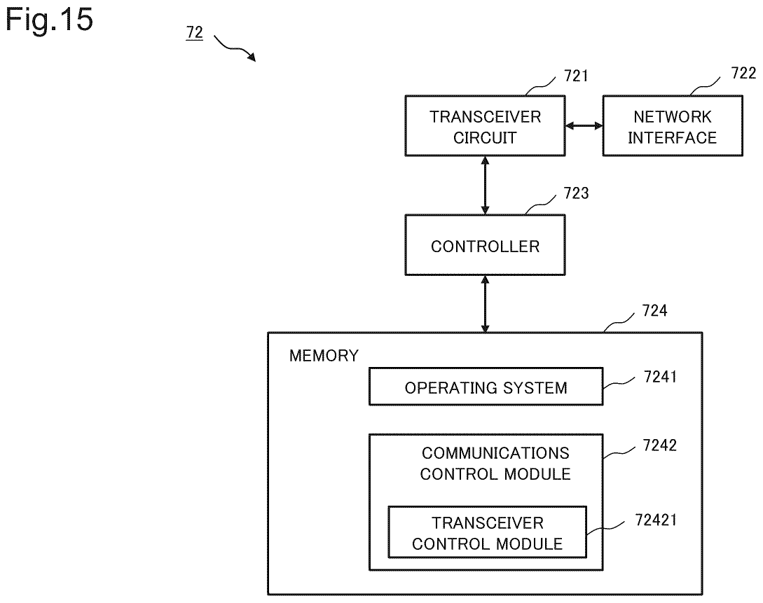

FIG. 15 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g. a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

### <PCF>

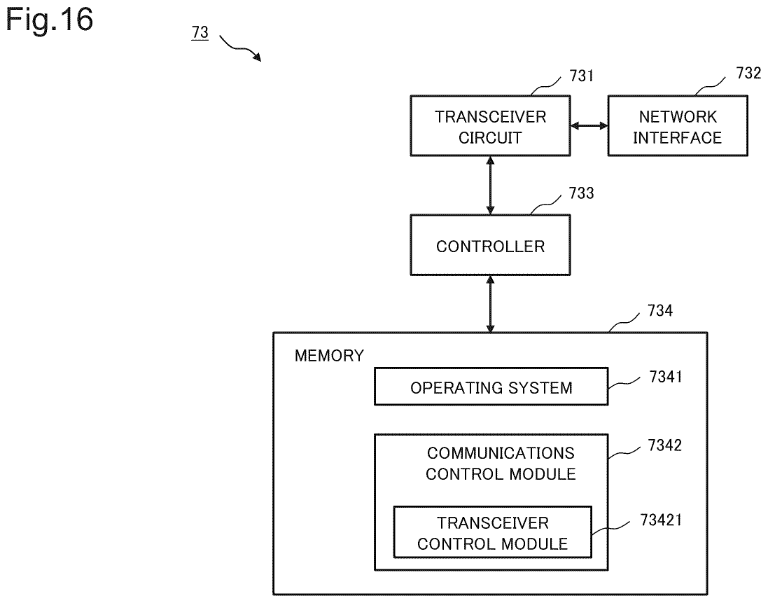

FIG. 16 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN). A PCF 7301 and a PCF 7302 may have same components to the PCF 73.

### <AUSF>

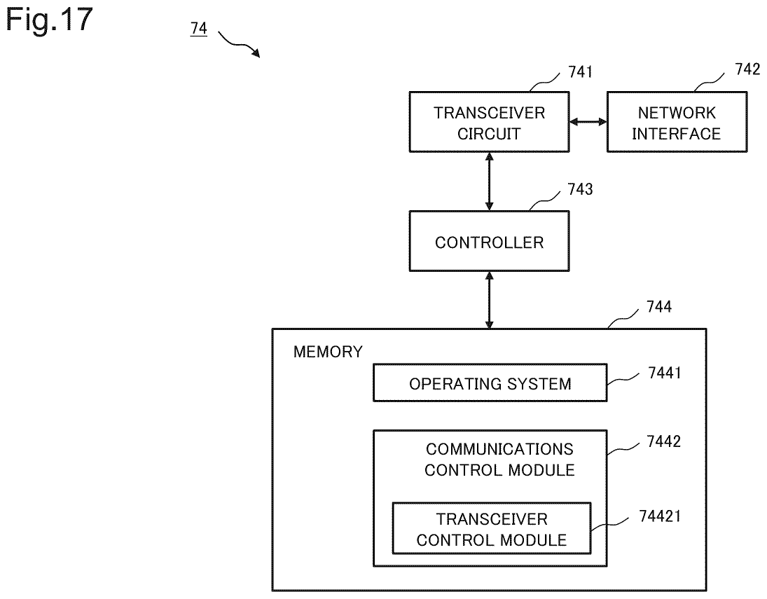

FIG. 17 is a block diagram illustrating the main components of the AUSF 74. As shown, the apparatus includes a transceiver circuit 741 which is operable to transmit signals to and to receive signals from other nodes (including the UDM 75) via a network interface 742. A controller 743 controls the operation of the AUSF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the AUSF 74 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The AUSF 74 may support the Non-Public Network (NPN), The NPN may be a Stand-alone Non-Public Network (SNPN) or a Public Network Integrated NPN (PNI-NPN).

### <UDM>

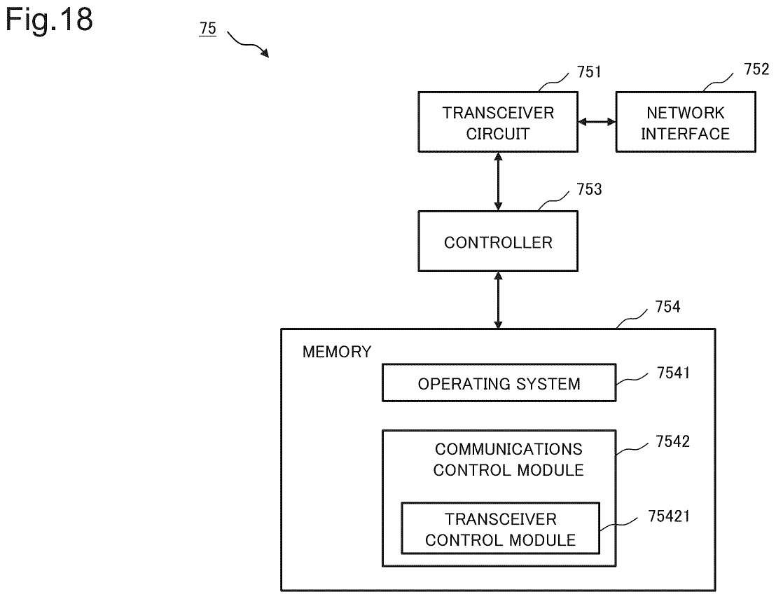

FIG. 18 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (RMD), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NWDAF>

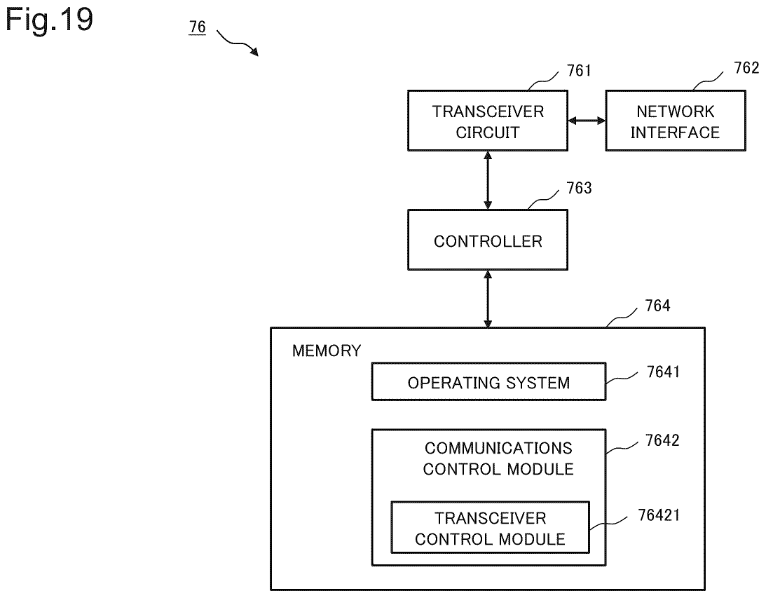

FIG. 19 is a block diagram illustrating the main components of the NWDAF 76. As shown, the apparatus includes a transceiver circuit 761 which is operable to transmit signals to and to receive signals from other nodes (including the AMF 70) via a network interface 762. A controller 763 controls the operation of the NWDAF 76 in accordance with the software stored in a memory 764. The Software may be pre-installed in the memory 764 and/or may be downloaded via the telecommunication network or from a removable data storage device (e.g. a removable memory device (RMD)), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NWDAF 76 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NWDAF 76 may support the Non-Public Network (NPN), The NPN may be a Stand-alone Non-Public Network (SNPN) or a Public Network Integrated NPN (PNI-NPN).

### <NEF>

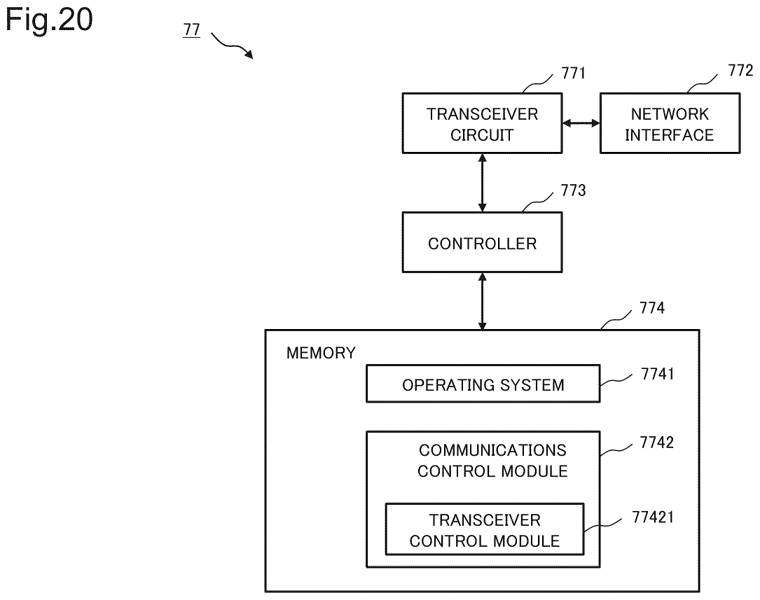

FIG. 20 is a block diagram illustrating the main components of the NEF 77. As shown, the apparatus includes a transceiver circuit 771 which is operable to transmit signals to and to receive signals from other nodes (including the UDM 75) via a network interface 772. A controller 773 controls the operation of the NEF 77 in accordance with software stored in a memory 774. Software may be pre-installed in the memory 774 and/or may be downloaded via the telecommunication network or from a removable data storage device (e.g. a removable memory device (RMD)), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the NEF 77 and other nodes, such as the UDM 75 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network exposure function procedures (for the UE 3).

The NEF 77 may support the Non-Public Network (NPN), The NPN may be a Stand-alone Non-Public Network (SNPN) or a Public Network Integrated NPN (PNI-NPN).

### <NSACF>

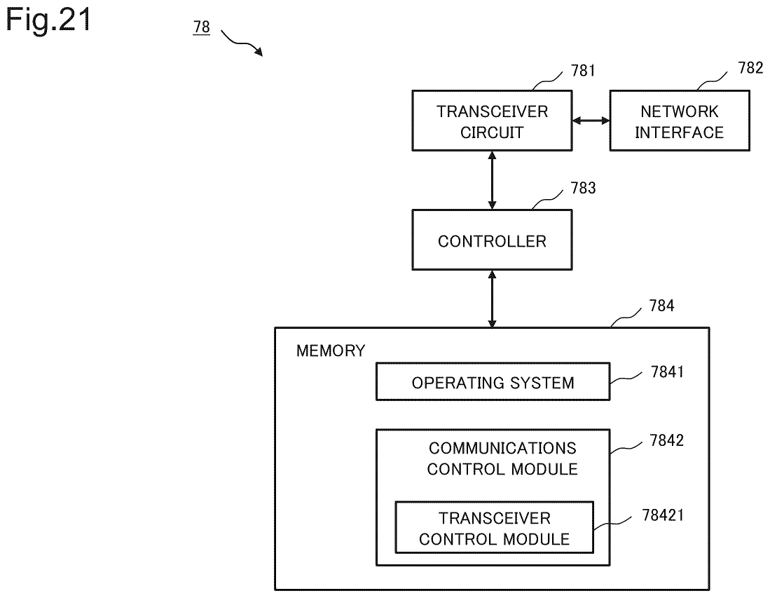

FIG. 21 is a block diagram illustrating the main components of the NSACF 78. As shown, the apparatus includes a transceiver circuit 781 which is operable to transmit signals to and to receive signals from other nodes (including the AMF 70) via a network interface 782. A controller 783 controls the operation of the NSACF 78 in accordance with the software stored in a memory 784. The Software may be pre-installed in the memory 784 and/or may be downloaded via the telecommunication network or from a removable data storage device (RMD), for example. The software includes, among other things, an operating system 7841 and a communications control module 7842 having at least a transceiver control module 78421. The communications control module 7842 (using its transceiver control module 78421 is responsible for handling (generating/sending/receiving) signalling between the NSACF 78 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NSACF 78 may support the Non-Public Network (NPN), The NPN may be a Stand-alone Non-Public Network (SNPN) or a Public Network Integrated NPN (PNI-NPN).

### <Other Core Network Nodes>

PGW-C+SMF 71 may have same components to the SMF 71 in the FIG. 14.

UPF+PGW-U 72 may have same components to the UPF 72 in the FIG. 15.

HSS+UDM 75 may have same components to the UDM 75 in the FIG. 18.

MME 80 may have same components to the AMF 70 in the FIG. 13 or the SMF 71 in the FIG. 14.

S-GW 81 may have same components to the AMF 70 in the FIG. 13, the SMF 71 in the FIG. 14, or the UPF 72 in the FIG. 15.

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules). Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors; microprocessors; central processing units (CPUs); arithmetic logic units (ALUs): input/output (IO) circuits; internal memories/caches (program and/or data); processing registers; communication buses (e.g. control, data and/or address buses); direct memory access (DMA) functions; hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

As will be appreciated by one of skill in the art, the present disclosure may be embodied as a method, and system. Accordingly, the present disclosure may take the form of an entirely hardware embodiment, a software embodiment or an embodiment combining software and hardware aspects.

It will be understood that each block of the block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. A general-purpose processor may be a microprocessor, but in the alternative, the processor may be any conventional processor, controller, microcontroller, or state machine. A processor may also be implemented as a combination of computing devices, e.g., a plurality of microprocessors, one or more microprocessors, or any other such configuration.

The methods or algorithms described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor. The processor and the storage medium may reside in an ASIC.

The previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS, and the Aspects are also applicable to communication system other than 5GS (e.g., 6G system, 5G beyond system).

### <First Supplementary Notes>

The whole or part of the example Aspects disclosed above can be described as, but not limited to, the following supplementary notes.
supplementary note 1. A method of a User Equipment (UE), the method comprising:
sending an Attach Request message including information to obtain a UE policy for the UE; and
receiving an Attach Accept message including the UE policy.
supplementary note 2. The method according to supplementary note 1,
wherein the information includes at least one of a UE policy list, a UE policy classmark and a UE OS ID.
supplementary note 3. A method of a communication apparatus, the method comprising:
receiving an Attach Request message including information to obtain a UE policy;
sending a Create Session Request message including the information;
receiving a Create Session Response message including the UE policy after sending the Create session Request message; and
sending an Attach Accept message including the UE policy.
supplementary note 4. The method according to supplementary note 3,
wherein the communication apparatus is a Mobility Management Entity (MME).
supplementary note 5. A method of a communication apparatus, the method comprising:
receiving a Create Session Request message including information to obtain a UE policy;
sending the Create Session Request message;
receiving a Create Session Response message including the UE policy after sending the Create session Request message; and
sending the Create Session Response message.
supplementary note 6. The method according to supplementary note 5,
wherein the communication apparatus is a Serving Gateway (S-GW).
supplementary note 7. A method of a communication apparatus, the method comprising:
receiving a Create Session Request message including information to obtain a UE policy;
sending a first message including the information;
receiving a second message including the UE policy after sending the first message; and
sending a third message including the UE policy.
supplementary note 8. The method according to supplementary note 7,
wherein the communication apparatus includes a Packet Data Network (PDN) Gateway Control plane function (PGW-C) and Session Management Function (SMF).
supplementary note 9. The method according to supplementary note 7 or 8,
wherein the first message is an Npcf_get_UEpolicy Request message,
wherein the second message is an Npcf_get_UEpolicy Response message, and
wherein the third message is a Create Session Response message.
supplementary note 10. A method of a communication apparatus, the method comprising:
receiving a first message including information to obtain a UE policy;
sending a second message including the information;
receiving a third message including the UE policy after sending the first message; and
sending a fourth message including the UE policy.
supplementary note 11. The method according to supplementary note 10,
wherein the communication apparatus is a Policy Control Function (PCF) apparatus.
supplementary note 12. The method according to supplementary note 10 or 11,
wherein the first message is an Npcf_get_UEpolicy Request message,
wherein the second message is an Nudm_get_UEpolicy Request message,
wherein the third message is an Nudm_get_UEpolicy Response message, and
wherein the fourth message is an Npcf_get_UEpolicy Response message.
supplementary note 13. A method of a communication apparatus, the method comprising:
receiving a first message including information to obtain a UE policy;
obtaining the UE policy; and
receiving a second message including the UE policy.
supplementary note 14. The method according to supplementary note 13,
wherein the communication apparatus is a Unified Data Management (UDM) apparatus.
supplementary note 15. The method according to supplementary note 13 or 14,
wherein the first message is an Nudm_get_UEpolicy Request message, and
wherein the second message is an Nudm_get_UEpolicy Response message.
supplementary note 16. A method of a communication apparatus, the method comprising:
receiving a first message including information to obtain a UE policy;
obtaining the UE policy; and
receiving a second message including the UE policy.
supplementary note 17. The method according to supplementary note 16,
wherein the communication apparatus is a Unified Data Repository (UDR) apparatus.
supplementary note 18. The method according to supplementary note 16 or 17,
wherein the first message is an Nudm_get_UEpolicy Request message, and
wherein the second message is an Nudm_get_UEpolicy Response message.
supplementary note 19. A method of a User Equipment (UE), the method comprising:
sending a first Evolved Packet System (EPS) session management (SM) message including information to obtain a UE policy for the UE; and
receiving a second EPS SM message including the UE policy.
supplementary note 20. The method according to supplementary note 19,
wherein the first EPS SM message include at least one of a UE policy list, a UE policy classmark and a UE OS ID.
supplementary note 21. A method of a communication apparatus, the method comprising:
receiving a first Evolved Packet System (EPS) session management (SM) message including information to obtain a UE policy;
sending a second EPS SM message including the information;
receiving a third EPS SM message including the UE policy after sending the second EPS SM message; and
sending a fourth EPS SM message including the UE policy.
supplementary note 22. The method according to supplementary note 21,
wherein the communication apparatus is a Mobility Management Entity (MME).
supplementary note 23. A method of a communication apparatus, the method comprising:
receiving a first Evolved Packet System (EPS) session management (SM) message including information to obtain a UE policy;
sending a second EPS SM message including the information;
receiving a third EPS SM message including the UE policy after sending the second EPS SM message; and
sending a fourth EPS SM message including the UE policy.
supplementary note 24. The method according to supplementary note 23,
wherein the communication apparatus is a Serving Gateway (S-GW).
supplementary note 25. A method of a communication apparatus, the method comprising:
receiving a first Evolved Packet System (EPS) session management (SM) message including information to obtain a UE policy;
sending a first message including the information;
receiving a second message including the UE policy after sending the first message; and
sending a second EPS SM message including the UE policy.
supplementary note 26. The method according to supplementary note 25,
wherein the communication apparatus includes a Packet Data Network (PDN) Gateway Control plane function (PGW-C) and Session Management Function (SMF).
supplementary note 27. The method according to supplementary note 25 or 26,
wherein the first message is an Npcf_get_UEpolicy Request message, and
wherein the second message is an Npcf_get_UEpolicy Response message.
supplementary note 28. A method of a User Equipment (UE), the method comprising:
sending a first Evolved Packet System (EPS) session management (SM) message including information to obtain a UE policy for the UE;
receiving a message including an indicator indicating that the UE policy is pending;
performing a selection of a cell;
performing a registration procedure to 5G system; and
receiving the UE policy after performing the registration procedure.
supplementary note 29. The method according to supplementary note 28,
wherein the information includes at least one of a UE policy list, a UE policy classmark and a UE OS ID.
supplementary note 30. A method of a communication apparatus, the method comprising:
receiving a first Evolved Packet System (EPS) session management (SM) message including information to obtain a UE policy;
sending a second EPS SM message including the information;
receiving a third EPS SM message including an indicator indicating that the UE policy is pending after sending the second EPS SM message; and
sending a message including the indicator.
supplementary note 31. The method according to supplementary note 30,
wherein the communication apparatus is a Mobility Management Entity (MME).
supplementary note 32. A method of a communication apparatus, the method comprising:
receiving a first Evolved Packet System (EPS) session management (SM) message including information to obtain a UE policy;
sending a second EPS SM message including the information;
receiving a third EPS SM message including an indicator indicating that the UE policy is pending after sending the second EPS SM message; and
sending a fourth EPS SM message including the indicator.
supplementary note 33. The method according to supplementary note 32,
wherein the communication apparatus is a Serving Gateway (S-GW).
supplementary note 34. A method of a communication apparatus, the method comprising:
receiving a message including an indicator indicating that a UE policy is pending;
receiving a first Evolved Packet System (EPS) session management (SM) message including information to obtain the UE policy; and
sending a second EPS SM message including the indicator.
supplementary note 35. The method according to supplementary note 34,
wherein the communication apparatus includes a Packet Data Network (PDN) Gateway Control plane function (PGW-C) and Session Management Function (SMF).
supplementary note 36. The method according to supplementary note 34 or 35,
wherein the message is an Npcf_UEPolicy_update_Notification message.
supplementary note 37. A method of a communication apparatus, the method comprising:
receiving a first message including a UE policy; and
sending a second message including an indicator indicating that the UE policy is pending.
supplementary note 38. The method according to supplementary note 10,
wherein the communication apparatus is a Policy Control Function (PCF) apparatus.
supplementary note 39. A method of a User Equipment (UE), the method comprising:
sending a Registration Request message,
wherein the Registration Request message includes information indicating that the UE supports reception of a UE policy for Evolved Packet System via 5G system; and
receiving the UE policy after sending the Registration Request message.
supplementary note 40. A method of a communication apparatus, the method comprising:
receiving a Registration Request message from a User Equipment (UE),
wherein the Registration Request message includes information indicating that the UE supports reception of a UE policy for Evolved Packet System via 5G system;
sending a message including the information;
receiving the UE policy after sending the message; and
sending the UE policy to the UE.
supplementary note 41. The method according to supplementary note 40,
wherein the communication apparatus is an Access and Mobility Management Function (AMF) apparatus.
supplementary note 42. The method according to supplementary note 40 or 41, further comprising:
receiving an indicator indicating that the UE policy is pending after sending the message; and
retaining an N1 connection in a case of receiving the indicator.
supplementary note 43. A method of a communication apparatus, the method comprising:
receiving a message,
wherein the message includes information indicating that a User Equipment (UE) supports reception of a UE policy for Evolved Packet System via 5G system; and
sending the UE policy after receiving the message.
supplementary note 44. The method according to supplementary note 43,
wherein the communication apparatus is a Policy Control Function (PCF) apparatus.
supplementary note 45. The method according to supplementary note 43 or 44, further comprising:
sending an indicator indicating that the UE policy is pending after receiving the message.
supplementary note 46. A User Equipment (UE) comprising:
means for sending an Attach Request message including information to obtain a UE policy for the UE; and
means for receiving an Attach Accept message including the UE policy.
supplementary note 47. The UE according to supplementary note 46,
wherein the information includes at least one of a UE policy list, a UE policy classmark and a UE OS ID.
supplementary note 48. A communication apparatus comprising:
means for receiving an Attach Request message including information to obtain a UE policy;
means for sending a Create Session Request message including the information;
means for receiving a Create Session Response message including the UE policy after sending the Create session Request message; and
means for sending an Attach Accept message including the UE policy.
supplementary note 49. The communication apparatus according to supplementary note 48,
wherein the communication apparatus is a Mobility Management Entity (MME).
supplementary note 50. A communication apparatus comprising:
means for receiving a Create Session Request message including information to obtain a UE policy;
means for sending the Create Session Request message;
means for receiving a Create Session Response message including the UE policy after sending the Create session Request message; and
means for sending the Create Session Response message.
supplementary note 51. The communication apparatus according to supplementary note 50,
wherein the communication apparatus is a Serving Gateway (S-GW).
supplementary note 52. A communication apparatus comprising:
means for receiving a Create Session Request message including information to obtain a UE policy;
means for sending a first message including the information;
means for receiving a second message including the UE policy after sending the first message; and
means for sending a third message including the UE policy.
supplementary note 53. The communication apparatus according to supplementary note 52,
wherein the communication apparatus includes a Packet Data Network (PDN) Gateway Control plane function (PGW-C) and Session Management Function (SMF).
supplementary note 54. The communication apparatus according to supplementary note 52 or 53,
wherein the first message is an Npcf_get_UEpolicy Request message,
wherein the second message is an Npcf_get_UEpolicy Response message, and
wherein the third message is a Create Session Response message.
supplementary note 55. A communication apparatus comprising:
means for receiving a first message including information to obtain a UE policy;
means for sending a second message including the information;
means for receiving a third message including the UE policy after sending the first message; and
means for sending a fourth message including the UE policy.
supplementary note 56. The communication apparatus according to supplementary note 55,
wherein the communication apparatus is a Policy Control Function (PCF) apparatus.
supplementary note 57. The communication apparatus according to supplementary note 55 or 56,
wherein the first message is an Npcf_get_UEpolicy Request message,
wherein the second message is an Nudm_get_UEpolicy Request message,
wherein the third message is an Nudm_get_UEpolicy Response message, and
wherein the fourth message is an Npcf_get_UEpolicy Response message.
supplementary note 58. A communication apparatus comprising:
means for receiving a first message including information to obtain a UE policy;
means for obtaining the UE policy; and
means for receiving a second message including the UE policy.
supplementary note 59. The communication apparatus according to supplementary note 58,
wherein the communication apparatus is a Unified Data Management (UDM) apparatus.
supplementary note 60. The communication apparatus according to supplementary note 59,
wherein the first message is an Nudm_get_UEpolicy Request message, and
wherein the second message is an Nudm_get_UEpolicy Response message.
supplementary note 61. A communication apparatus comprising:
means for receiving a first message including information to obtain a UE policy;
means for obtaining the UE policy; and
means for receiving a second message including the UE policy.
supplementary note 62. The communication apparatus according to supplementary note 61,
wherein the communication apparatus is a Unified Data Repository (UDR) apparatus.
supplementary note 63. The communication apparatus according to supplementary note 61 or 62,
wherein the first message is an Nudm_get_UEpolicy Request message, and
wherein the second message is an Nudm_get_UEpolicy Response message.
supplementary note 64. A User Equipment (UE) comprising:
means for sending a first Evolved Packet System (EPS) session management (SM) message including information to obtain a UE policy for the UE; and
means for receiving a second EPS SM message including the UE policy.
supplementary note 65. The UE according to supplementary note 64,
wherein the first EPS SM message include at least one of a UE policy list, a UE policy classmark and a UE OS ID.
supplementary note 66. A communication apparatus comprising:
means for receiving a first Evolved Packet System (EPS) session management (SM) message including information to obtain a UE policy;
means for sending a second EPS SM message including the information;
means for receiving a third EPS SM message including the UE policy after sending the second EPS SM message; and
means for sending a fourth EPS SM message including the UE policy.
supplementary note 67. The communication apparatus according to supplementary note 66,
wherein the communication apparatus is a Mobility Management Entity (MME).
supplementary note 68. A communication apparatus comprising:
means for receiving a first Evolved Packet System (EPS) session management (SM) message including information to obtain a UE policy;
means for sending a second EPS SM message including the information;
means for receiving a third EPS SM message including the UE policy after sending the second EPS SM message; and
means for sending a fourth EPS SM message including the UE policy.
supplementary note 69. The communication apparatus according to supplementary note 68,
wherein the communication apparatus is a Serving Gateway (S-GW).
supplementary note 70. A communication apparatus comprising:
means for receiving a first Evolved Packet System (EPS) session management (SM) message including information to obtain a UE policy;
means for sending a first message including the information;
means for receiving a second message including the UE policy after sending the first message; and
means for sending a second EPS SM message including the UE policy.
supplementary note 71. The communication apparatus according to supplementary note 70,
wherein the communication apparatus includes a Packet Data Network (PDN) Gateway Control plane function (PGW-C) and Session Management Function (SMF).
supplementary note 72. The communication apparatus according to supplementary note 70 or 71,
wherein the first message is an Npcf_get_UEpolicy Request message, and
wherein the second message is an Npcf_get_UEpolicy Response message.
supplementary note 73. A User Equipment (UE) comprising:
means for sending a first Evolved Packet System (EPS) session management (SM) message including information to obtain a UE policy for the UE;
means for receiving a message including an indicator indicating that the UE policy is pending;
means for performing a selection of a cell;
means for performing a registration procedure to 5G system; and
means for receiving the UE policy after performing the registration procedure.
supplementary note 74. The UE according to supplementary note 73,
wherein the information includes at least one of a UE policy list, a UE policy classmark and a UE OS ID.
supplementary note 75. A communication apparatus comprising:
means for receiving a first Evolved Packet System (EPS) session management (SM) message including information to obtain a UE policy;
means for sending a second EPS SM message including the information;
means for receiving a third EPS SM message including an indicator indicating that the UE policy is pending after sending the second EPS SM message; and
means for sending a message including the indicator.
supplementary note 76. The communication apparatus according to supplementary note 75,
wherein the communication apparatus is a Mobility Management Entity (MME).
supplementary note 77. A communication apparatus comprising:
means for receiving a first Evolved Packet System (EPS) session management (SM) message including information to obtain a UE policy;
means for sending a second EPS SM message including the information;
means for receiving a third EPS SM message including an indicator indicating that the UE policy is pending after sending the second EPS SM message; and
means for sending a fourth EPS SM message including the indicator.
supplementary note 78. The communication apparatus according to supplementary note 77,
wherein the communication apparatus is a Serving Gateway (S-GW).
supplementary note 79. A communication apparatus comprising:
means for receiving a message including an indicator indicating that a UE policy is pending;
means for receiving a first Evolved Packet System (EPS) session management (SM) message including information to obtain the UE policy; and
means for sending a second EPS SM message including the indicator.
supplementary note 80. The communication apparatus according to supplementary note 79,
wherein the communication apparatus includes a Packet Data Network (PDN) Gateway Control plane function (PGW-C) and Session Management Function (SMF).
supplementary note 81. The communication apparatus according to supplementary note 79 or 80,
wherein the message is an Npcf_UEPolicy_update_Notification message.
supplementary note 82. A communication apparatus comprising:
means for receiving a first message including a UE policy; and
means for sending a second message including an indicator indicating that the UE policy is pending.
supplementary note 83. The communication apparatus according to supplementary note 82,
wherein the communication apparatus is a Policy Control Function (PCF) apparatus.
supplementary note 84. A User Equipment (UE) comprising:
means for sending a Registration Request message,
wherein the Registration Request message includes information indicating that the UE supports reception of a UE policy for Evolved Packet System via 5G system; and
means for receiving the UE policy after sending the Registration Request message.
supplementary note 85. A communication apparatus comprising:
means for receiving a Registration Request message from a User Equipment (UE),
wherein the Registration Request message includes information indicating that the UE supports reception of a UE policy for Evolved Packet System via 5G system;
means for sending a message including the information;
means for receiving the UE policy after sending the message; and
means for sending the UE policy to the UE.
supplementary note 86. The communication apparatus according to supplementary note 85,
wherein the communication apparatus is an Access and Mobility Management Function (AMF) apparatus.
supplementary note 87. The communication apparatus according to supplementary note 85 or 86, further comprising:
means for receiving an indicator indicating that the UE policy is pending after sending the message; and
means for retaining an N1 connection in a case of receiving the indicator.
supplementary note 88. A communication apparatus comprising:
means for receiving a message,
wherein the message includes information indicating that a User Equipment (UE) supports reception of a UE policy for Evolved Packet System via 5G system; and
means for sending the UE policy after receiving the message.
supplementary note 89. The communication apparatus according to supplementary note 88,
wherein the communication apparatus is a Policy Control Function (PCF) apparatus.
supplementary note 90. The communication apparatus according to supplementary note 88 or 89, further comprising:
means for sending an indicator indicating that the UE policy is pending after receiving the message.

### <Second Supplementary Notes>

The whole or part of the example Aspects disclosed above can be described as, but not limited to, the following supplementary notes.
supplementary note 1. A method of a User Equipment (UE), the method comprising:
sending, to a Mobility Management Entity (MME), a first message including information to obtain a UE policy; and
receiving, from the MME, a second message including the UE policy.
supplementary note 2. The method according to supplementary note 1,
wherein the information includes at least one of a UE policy list, a UE policy classmark, and a UE OS ID.
supplementary note 3. The method according to supplementary note 1 or 2,
wherein the information is a Protocol Configuration Options (PCO).
supplementary note 4. The method according to any one of supplementary notes 1 to 3,
wherein the UE policy is a UE Route Selection Policy (URSP).
supplementary note 5. The method according to any one of supplementary notes 1 to 4,
wherein the first message is an Attach Request message or a Packet Data Network (PDN) connectivity request message, and
wherein the second message is an Attach Accept message or a Bearer Modify Request message.
supplementary note 6. The method according to any one of supplementary notes 1 to 5,
wherein the UE receives the second message from the MME, in a case where a Policy Control Function (PCF) decided to update the UE policy.
supplementary note 7. The method according to any one of supplementary notes 1 to 6,
wherein the UE indicates, to a 5G System (5GS), its capability for receiving and handling the UE policy in an Evolved Packet System (EPS).
supplementary note 8. The method according to any one of supplementary notes 1 to 4,
wherein the first message is a first Evolved Packet System (EPS) Session Management (ESM) message, and
wherein the second message is a second ESM message.
supplementary note 9. The method according to supplementary note 8,
wherein the first ESM message is a Packet Data Network (PDN) connectivity request message, and
wherein the second ESM message is an Activate Default EPS Bearer Context Request message.
supplementary note 10. A method of a communication apparatus, the method comprising:
receiving, from a User Equipment (UE), a first message including information to obtain a UE policy;
sending, to a Serving Gateway (S-GW), a second message including the information;
receiving, from the S-GW, a third message including the UE policy; and
sending, to the UE, a fourth message including the UE policy,
wherein the communication apparatus is a Mobility Management Entity (MME).
supplementary note 11. The method according to supplementary note 10,
wherein the UE policy is a UE Route Selection Policy (URSP).
supplementary note 12. The method according to supplementary note 10 or 11,
wherein the first message is an Attach Request message or a Packet Data Network (PDN) connectivity request message,
wherein the second message is a Create Session Request message,
wherein the third message is a Create Session Response message or an Update Bearer Request message, and
wherein the fourth message is an Attach Accept message or a Bearer Modify Request message.
supplementary note 13. The method according to any one of supplementary notes 10 to 12,
wherein the MME receives the third message from the S-GW and sends the fourth message to the UE, in a case where a Policy Control Function (PCF) decided to update the UE policy.
supplementary note 14. The method according to supplementary note 10 or 11,
wherein the first message is a first Evolved Packet System (EPS) Session Management (ESM) message,
wherein the second message is a second ESM message,
wherein the third message is a third ESM message, and
wherein the fourth message is a fourth ESM message.
supplementary note 15. The method according to supplementary note 14,
wherein the first ESM message is a PDN connectivity request message,
wherein the third ESM message is a Create session response message, and
wherein the fourth ESM message is an Activate Default EPS Bearer Context Request message.
supplementary note 16. A method of a communication apparatus, the method comprising:
receiving, from a Mobility Management Entity (MME), a first message including information to obtain a UE policy;
sending, to a Packet Data Network (PDN) Gateway Control plane function (PGW-C) and Session Management Function (SMF), a second message including the information;
receiving, from the PGW-C and SMF, a third message including the UE policy; and
sending, to the MME, a fourth message including the UE policy,
wherein the communication apparatus is a Serving Gateway (S-GW).
supplementary note 17. The method according to supplementary note 16,
wherein the UE policy is a UE Route Selection Policy (URSP).
supplementary note 18. The method according to supplementary note 16 or 17,
wherein the first message is a Create Session Request message,
wherein the second message is the Create Session Request message,
wherein the third message is a Create Session Response message or an Update Bearer Request message, and
wherein the fourth message is the Create Session Response message or the Update Bearer Request message.
supplementary note 19. The method according to any one of supplementary notes 16 to 18,
wherein the S-GW receives the third message from the PGW-C and SMF and sends the fourth message to the MME, in a case where a Policy Control Function (PCF) decided to update the UE policy.
supplementary note 20. The method according to supplementary note 16 or 17,
wherein the first message is a first Evolved Packet System (EPS) Session Management (ESM) message,
wherein the second message is a second ESM message,
wherein the third message is a third ESM message, and
wherein the fourth message is a fourth ESM message.
supplementary note 21. A method of a communication apparatus, the method comprising:
receiving, from a Serving Gateway (S-GW), a first message including information to obtain a UE policy;
sending, to a Policy Control Function (PCF), a second message including the information;
receiving, from the PCF, a third message including the UE policy; and
sending, to the S-GW, a fourth message including the UE policy,
wherein the communication apparatus is a Packet Data Network (PDN) Gateway Control plane function (PGW-C) and Session Management Function (SMF).
supplementary note 22. The method according to supplementary note 21,
wherein the UE policy is a UE Route Selection Policy (URSP).
supplementary note 23. The method according to supplementary note 21 or 22,
wherein the first message a Create Session Request message,
wherein the second message is an Npcf_get_UEpolicy Request message,
wherein the third message is an Npcf_get_UEpolicy Response message or an Npcf_UEPolicyControl_UpdateNotify message, and
wherein the fourth message is a Create Session Response message or an Update Bearer Request message.
supplementary note 24. The method according to any one of supplementary notes 21 to 23,
wherein the PGW-C and SMF receives the third message from the PCF and sends the fourth message to the S-GW, in a case where the PCF decided to update the UE policy.
supplementary note 25. The method according to supplementary note 21 or 22,
wherein the first message is a first Evolved Packet System (EPS) Session Management (ESM) message, and
wherein the fourth message is a second ESM message.
supplementary note 26. A method of a communication apparatus, the method comprising:
receiving, form a Packet Data Network (PDN) Gateway Control plane function (PGW-C) and Session Management Function (SMF), a first message including information to obtain a UE policy;
sending, to a Unified Data Management (UDM) or a Unified Data Repository (UDR), a second message including the information;
receiving, from the UDM or the UDR, a third message including the UE policy; and
sending, to the PGW-C and SMF, a fourth message including the UE policy,
wherein the communication apparatus is a Policy Control Function (PCF).
supplementary note 27. The method according to supplementary note 26,
wherein the UE policy is a UE Route Selection Policy (URSP).
supplementary note 28. The method according to supplementary note 26 or 27,
wherein the first message is an Npcf_get_UEpolicy Request message,
wherein the second message is an Nudm_get_UEpolicy Request message,
wherein the third message is an Nudm_get_UEpolicy Response message, and
wherein the fourth message is an Npcf_get_UEpolicy Response message or an Npcf_UEPolicy Control_UpdateNotify message.
supplementary note 29. The method according to any one of supplementary notes 26 to 28,
wherein the PCF sends the fourth message to the PGW-C and SMF, in a case where the PCF decided to update the UE policy.
supplementary note 30. A User Equipment (UE) comprising:
means for sending, to a Mobility Management Entity (MME), a first message including information to obtain a UE policy; and
means for receiving, from the MME, a second message including the UE policy.
supplementary note 31. The UE according to supplementary note 30,
wherein the information includes at least one of a UE policy list, a UE policy classmark, and a UE OS ID.
supplementary note 32. The UE according to supplementary note 30 or 31,
wherein the information is a Protocol Configuration Options (PCO).
supplementary note 33. The UE according to any one of supplementary notes 30 to 32,
wherein the UE policy is a UE Route Selection Policy (URSP).
supplementary note 34. The UE according to any one of supplementary notes 30 to 33,
wherein the first message is an Attach Request message or a Packet Data Network (PDN) connectivity request message, and
wherein the second message is an Attach Accept message or a Bearer Modify Request message.
supplementary note 35. The UE according to any one of supplementary notes 30 to 34,
wherein the UE receives the second message from the MME, in a case where a Policy Control Function (PCF) decided to update the UE policy.
supplementary note 36. The UE according to any one of supplementary notes 30 to 35,
wherein the UE indicates, to a 5G System (5GS), its capability for receiving and handling the UE policy in an Evolved Packet System (EPS).
supplementary note 37. The UE according to any one of supplementary notes 30 to 33,
wherein the first message is a first Evolved Packet System (EPS) Session Management (ESM) message, and
wherein the second message is a second ESM message.
supplementary note 38. The UE according to supplementary note 37,
wherein the first ESM message is a Packet Data Network (PDN) connectivity request message, and
wherein the second ESM message is an Activate Default EPS Bearer Context Request message.
supplementary note 39. A communication apparatus comprising:
means for receiving from a User Equipment (UE), a first message including information to obtain a UE policy;
means for sending, to a Serving Gateway (S-GW), a second message including the information;
means for receiving, from the S-GW, a third message including the UE policy; and
means for sending, to the UE, a fourth message including the UE policy,
wherein the communication apparatus is a Mobility Management Entity (MME).
supplementary note 40. The communication apparatus according to supplementary note 39,
wherein the UE policy is a UE Route Selection Policy (URSP).
supplementary note 41. The communication apparatus according to supplementary note 39 or 40,
wherein the first message is an Attach Request message or a Packet Data Network (PDN) connectivity request message,
wherein the second message is a Create Session Request message,
wherein the third message is a Create Session Response message or an Update Bearer Request message, and
wherein the fourth message is an Attach Accept message or a Bearer Modify Request message.
supplementary note 42. The communication apparatus according to any one of supplementary notes 39 to 41,
wherein the MME receives the third message from the S-GW and sends the fourth message to the UE, in a case where a Policy Control Function (PCF) decided to update the UE policy.
supplementary note 43. The communication apparatus according to supplementary note 39 or 40,
wherein the first message is a first Evolved Packet System (EPS) Session Management (ESM) message,
wherein the second message is a second ESM message,
wherein the third message is a third ESM message, and
wherein the fourth message is a fourth ESM message.
supplementary note 44. The communication apparatus according to supplementary note 43,
wherein the first ESM message is a PDN connectivity request message,
wherein the third ESM message is a Create session response message, and
wherein the fourth ESM message is an Activate Default EPS Bearer Context Request message.
supplementary note 45. A communication apparatus comprising:
means for receiving, from a Mobility Management Entity (MME), a first message including information to obtain a UE policy;
means for sending, to a Packet Data Network (PDN) Gateway Control plane function (PGW-C) and Session Management Function (SMF), a second message including the information;
means for receiving, from the PGW-C and SMF, a third message including the UE policy; and
means for sending, to the MME, a fourth message including the UE policy,
wherein the communication apparatus is a Serving Gateway (S-GW).
supplementary note 46. The communication apparatus according to supplementary note 45,
wherein the UE policy is a UE Route Selection Policy (URSP).
supplementary note 47. The communication apparatus according to supplementary note 45 or 46,
wherein the first message is a Create Session Request message,
wherein the second message is the Create Session Request message,
wherein the third message is a Create Session Response message or an Update Bearer Request message, and
wherein the fourth message is the Create Session Response message or the Update Bearer Request message.
supplementary note 48. The communication apparatus according to any one of supplementary notes 45 to 47,
wherein the S-GW receives the third message from the PGW-C and SMF and sends the fourth message to the MME, in a case where a Policy Control Function (PCF) decided to update the UE policy.
supplementary note 49. The communication apparatus according to supplementary note 45 or 46,
wherein the first message is a first Evolved Packet System (EPS) Session Management (ESM) message,
wherein the second message is a second ESM message,
wherein the third message is a third ESM message, and
wherein the fourth message is a fourth ESM message.
supplementary note 50. A communication apparatus comprising:
means for receiving, from a Serving Gateway (S-GW), a first message including information to obtain a UE policy;
means for sending, to a Policy Control Function (PCF), a second message including the information;
means for receiving, from the PCF, a third message including the UE policy; and
means for sending, to the S-GW, a fourth message including the UE policy,
wherein the communication apparatus is a Packet Data Network (PDN) Gateway Control plane function (PGW-C) and Session Management Function (SMF).
supplementary note 51. The communication apparatus according to supplementary note 50,
wherein the UE policy is a UE Route Selection Policy (URSP).
supplementary note 52. The communication apparatus according to supplementary note 50 or 51,
wherein the first message a Create Session Request message,
wherein the second message is an Npcf_get_UEpolicy Request message,
wherein the third message is an Npcf_get_UEpolicy Response message or an Npcf_UEPolicyControl_UpdateNotify message, and
wherein the fourth message is a Create Session Response message or an Update Bearer Request message.
supplementary note 53. The communication apparatus according to any one of supplementary notes 50 to 52,
wherein the PGW-C and SMF receives the third message from the PCF and sends the fourth message to the S-GW, in a case where the PCF decided to update the UE policy.
supplementary note 54. The communication apparatus according to supplementary note 50 or 51,
wherein the first message is a first Evolved Packet System (EPS) Session Management (ESM) message, and
wherein the fourth message is a second ESM message.
supplementary note 55. A communication apparatus comprising:
means for receiving, form a Packet Data Network (PDN) Gateway Control plane function (PGW-C) and Session Management Function (SMF), a first message including information to obtain a UE policy;
means for sending, to a Unified Data Management (UDM) or a Unified Data Repository (UDR), a second message including the information;
means for receiving, from the UDM or the UDR, a third message including the UE policy; and
means for sending, to the PGW-C and SMF, a fourth message including the UE policy,
wherein the communication apparatus is a Policy Control Function (PCF).
supplementary note 56. The communication apparatus according to supplementary note 55,
wherein the UE policy is a UE Route Selection Policy (URSP).
supplementary note 57. The communication apparatus according to supplementary note 55 or 56,
wherein the first message is an Npcf_get_UEpolicy Request message,
wherein the second message is an Nudm_get_UEpolicy Request message,
wherein the third message is an Nudm_get_UEpolicy Response message, and
wherein the fourth message is an Npcf_get_UEpolicy Response message or an Npcf_UEPolicyControl_UpdateNotify message.
supplementary note 58. The communication apparatus according to any one of supplementary notes 55 to 57,
wherein the PCF sends the fourth message to the PGW-C and SMF, in a case where the PCF decided to update the UE policy.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202211004541, filed on Jan. 27, 2022, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 AUSF
75 UDM
76 NWDAF
77 NEF
78 NSACF
80 MME
81 SGW
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
711 transceiver circuit
712 network interface
713 controller
714 memory
721 transceiver circuit
722 network interface
723 controller
724 memory
731 transceiver circuit
732 network interface
733 controller
734 memory
741 transceiver circuit
742 network interface
743 controller
744 memory
751 transceiver circuit
752 network interface
753 controller
754 memory
761 transceiver circuit
762 network interface
763 controller
764 memory
771 transceiver circuit
772 network interface
773 controller
774 memory
781 transceiver circuit
782 network interface
783 controller
784 memory
3621 transceiver control module
5521 transceiver control module
6051 operating system
6052 communications control module
6141 operating system
6142 communications control module
6241 operating system
6242 communications control module
7001 AMF
7002 AMF
7041 operating system
7042 communications control module
7141 operating system
7142 communications control module
7241 operating system
7242 communications control module
7341 operating system
7342 communications control module
7441 operating system
7442 communications control module
7541 operating system
7542 communications control module
7641 operating system
7642 communications control module
7741 operating system
7742 communications control module
7841 operating system
7842 communications control module
60521 transceiver control module
61421 transceiver control module
62421 transceiver control module
70421 transceiver control module
71421 transceiver control module
72421 transceiver control module
73421 transceiver control module
74421 transceiver control module
75421 transceiver control module
76421 transceiver control module
77421 transceiver control module
78421 transceiver control module

What is claimed is:

1. A method of a User Equipment (UE), the method comprising:
supporting UE Policy handling in an Evolved Packet System (EPS); and
sending, to Access and Mobility Management Function (AMF) apparatus, a parameter indicating support of the UE Policy handling in the EPS in a first message.

2. The method according to claim 1,
wherein the UE Policy is a UE Route Selection Policy (URSP).

3. The method according to claim 1,
wherein the UE Policy handling is a UE Route Selection Policy (URSP) provisioning.

4-20. (canceled)

21. A method of a communication apparatus, the method comprising:
receiving, from a Policy Control Function (PCF) apparatus, a User Equipment (UE) Policy; and
sending, to a UE, the UE Policy via a Protocol Configuration Options (PCO) related parameter,
wherein the communication apparatus is a Packet Data Network (PDN) Gateway Control plane function (PGW-C) and Session Management Function (SMF) apparatus.

22. The method according to claim 21,
wherein the UE Policy relates to a UE Route Selection Policy (URSP).

23. (canceled)

24. The method according to claim 21,
wherein the receiving the UE Policy is based on the PCF-decided apparatus deciding to update the UE Policy in the UE via an Evolved Packet System (EPS).

25-29. (canceled)

30. A User Equipment (UE) comprising:
one or more memories storing instructions; and
one or more processors configured to execute the instructions to:
support UE Policy handling in an Evolved Packet System (EPS); and
send, to a Access and Mobility Management Function (AMF) apparatus, a parameter indicating support of the UE Policy handling in the EPS in a first message.

31. The UE according to claim 30,
wherein the UE Policy is a UE Route Selection Policy (URSP).

32. The UE according to claim 30,
wherein the UE Policy handling is a UE Route Selection Policy (URSP) provisioning.

33-49. (canceled)

50. A communication apparatus comprising:
one or more memories storing instructions; and
one or more processors configured to execute the instructions to:
receive, from a Policy Control Function (PCF) apparatus, a User Equipment (UE) Policy; and
send, to a UE, the UE Policy via a Protocol Configuration Options (PCO) related parameter,
wherein the communication apparatus is a Packet Data Network (PDN) Gateway Control plane function (PGW-C) and Session Management Function (SMF) apparatus.

51. The communication apparatus according to claim 50,
wherein the UE Policy relates to a UE Route Selection Policy (URSP).

52. (canceled)

53. The communication apparatus according to claim 50,
wherein the UE Policy is received based on the PCF apparatus deciding to update the UE Policy in the UE via an Evolved Packet System (EPS).

54-58. (canceled)
